(19) United States
(12) Patent Application Publication
(10) Pub. No.: US 2025/0363146 A1
(43) Pub. Date: Nov. 27, 2025

(54) SYSTEM AND METHOD FOR AUTONOMOUS EMBEDDED COMPLIANCE

(71) Applicant: Konfer, Inc., Milpitas, CA (US)

(72) Inventor: Baskar Jayaraman, Fremont, CA (US)

(21) Appl. No.: 19/215,193

(22) Filed: May 21, 2025

Related U.S. Application Data
(60) Provisional application No. 63/650,367, filed on May 21, 2024.

(51) Int. Cl. G06F 16/3329; G06F 16/334; G06F 16/387; G06F 40/205

(52) U.S. Cl. CPC G06F 16/33295; G06F 16/334; G06F 16/387; G06F 40/205

(57) ABSTRACT

A computer-implemented method of automatically generating interactive compliance controls by a server computer system to a client computing system is provided. The method includes receiving, by the server computer system, a first input from the client computing system. The first input provides an electronic rules document including a plurality of compliance rules or identifying information for the electronic rules document, and information related to an asset. The method also includes outputting, by the server computer system to the client computing system and in response to the first input, controls corresponding to the compliance rules. The controls being rephrasings of the compliance rules and generated by inputting the electronic document into a first large language model (LLM). The first LLM being pretrained by examples specifying acceptable and unacceptable control outputs for a plurality of compliance rule inputs.

The present disclosure relates generally to a system for processing electronic documents using machine learning models, and more specifically to a system for processing electronic documents using machine learning models for generating interactive asset-specific compliance tools to a client computing system.

### BACKGROUND

Existing enterprise software systems can be used to implement assets such as artificial intelligence tools, but there is no interactive computer system that can process electronic rules documents into a digestible form usable by machine learning modules to generate compliance controls for the assets, or automatically assess compliance with the controls by accessing records of the enterprise software system.

U.S. Pat. No. 11,539,748 B2 discloses a method and system for compliance determination that is able to orchestrate compliance verification across a variety of software products. However, this system is unable to automatically process electronic rules documents into a digestible form usable by machine learning modules to generate compliance controls for the assets, while also automatically evaluating compliance with these controls within the enterprise software system.

U.S. Pat. No. 11,087,225 B2 discloses a method and system for identifying compliance-related information. However, this system is unable to automatically process electronic rules documents into a digestible form usable by machine learning modules to generate compliance controls for the assets, while also automatically evaluating compliance with these controls within the enterprise software system.

### SUMMARY

A computer-implemented method of automatically generating interactive compliance controls by a server computer system to a client computing system is provided. The method includes receiving, by the server computer system, a first input from the client computing system, the first input providing: an electronic rules document or identifying information for the electronic rules document, the electronic rules document including a plurality of compliance rules; and information related to an asset; and outputting, by the server computer system to the client computing system and in response to the first input, generated controls corresponding to the compliance rules, the generated controls being rephrasings of the compliance rules as actionable questions and generated by inputting the electronic document into a first large language model (LLM), the first LLM generating the rules based on example inputs specifying acceptable and unacceptable control outputs for a plurality of compliance rule inputs.

In examples, the method further includes receiving or accessing, by the server computer system, electronic documents providing information about the asset; inputting, by the server computer system, the electronic documents providing information about the asset into a second large language model (LLM), the second LLM being pretrained to generate answers to each of the generated controls by examples illustrating relationships between each control, a corresponding set of documents, a corresponding set of answers from the set of documents and a corresponding set of snippets.

In examples, the method further includes comparing each of the answers to a corresponding ideal answer and generating a score for each answer indicating whether the answer equates to the ideal answer; arranging the generated controls into a plurality of controls levels and generating an aggregated score for each of the controls levels; and outputting the aggregated score for each of the controls levels on a graphical user interface.

In examples, the method further includes generating the corresponding ideal answers by inputting, by the server computer system, the generated controls into an ideal answer LLM being pretrained to generate ideal answers to each of the generated controls by a list of strings containing an ideal answer example and an associated example input control.

In examples, a method as recited claim 1 further including replacing cross-references in the electronic rules document with natural language text of the cross-references by: replacing inter-document cross-references in the electronic rules document with source text of the cross-references retrieved from one or more further natural language electronic rules documents each including at least one of the cross-references; and/or replacing intra-document cross-references in the electronic rules document with source text from other portions of the electronic rules document.

In examples, the replacing cross-references in the electronic rules document with source text of the inter-document and/or intra-document cross-references includes: generating a first knowledge graph, the first knowledge graph including a plurality of first nodes representing text of the electronic rules document and the source text of the cross-references, the first nodes including first base text nodes including the text of the electronic rules document and first cross-reference nodes including the source text of the cross-references, each of the first cross-reference nodes being linked to a corresponding one of the first base text nodes by bidirectional pointers.

In examples, the generating the first knowledge graph includes: attaching first metadata to each of the first base text nodes, the first metadata including location information identifying a relevant location of the text of each of the first base text nodes within the electronic rules document; and attaching first metadata to each of the first cross-reference nodes, the first metadata including location information identifying a relevant location of the source text of the inter-document and/or intra-document cross-references within the electronic rules document or the one or more further electronic rules documents.

In examples, the replacing of the cross-references in the electronic rules document with source text of the inter-document and/or intra-document cross-references includes: generating a second knowledge graph, the second knowledge graph including a plurality of second nodes including the location information of the first metadata; and attaching second metadata to each of the second nodes, the second metadata includes text of the plurality of rules and the text of the of cross-references, the second metadata including second base text metadata including the text of the plurality of rules and second cross-reference text metadata including the text of the plurality of cross-references, the second nodes including: second base location nodes including the location information identifying the relevant location of the text of each of the second base text metadata within the natural language electronic rules document; and second cross-reference location nodes the location information identifying the relevant location of the source text of the inter-document and/or intra-document cross-references within the natural language electronic rules document or the one or more further natural language electronic rules documents, each of the second cross-reference location nodes being linked to a corresponding one of the second base location nodes by bidirectional pointers.

In examples, the method further includes inputting into a LLM: the electronic rules document; structured data objects each including a plurality of examples of acceptable and unacceptable controls for a respective example document; and instructions to process the electronic rules document and output the generated controls to correspond to the acceptable controls and to not correspond to the unacceptable controls.

In examples, the generated controls are questions that are factual, actionable, closed-ended and present tense and have a yes or no answer.

In examples, the examples of acceptable controls are grammatically correct and useful in determining whether the asset is compliant or non-compliant with rules in the electronic rules document.

In examples, the method further includes creating a first data structure including a plurality of first structured data objects each associating a portion of the text of the electronic rules document with location information identifying the relevant location of the portion of the text in the electronic rules document; creating a second data structure including a plurality of second structured data objects each associating each of the generated controls with an associated portion of the text of the electronic rules document; generating a third data structure including a plurality of third structured data objects each associating each of the generated controls with location information identifying the relevant location of the associated portion text in the electronic rules document by performing a string match of the text in the first data structure and the text in the second data structure.

In examples, the method further includes inputting into a LLM: a data structure including example questions and for each example question an example ideal answer indicating an assert complies with a rule; the generated controls; and instructions for generating ideal answers for the generated controls based on the example questions and the example ideal answers.

In examples, the method further includes assigning a factor to each of the generated controls, the factors categorizing each generated control according to topics covered by the generated controls.

In examples, assigning a factor to each of the generated controls includes performing the steps of: comparing, via a LLM, each of the generated controls to preexisting factors, a description of each preexisting factor and preexisting controls that are assigned to each factor, and: generating a factor categorization for a first subset of the generated controls by assigning each of the generated controls of the first subset a respective one of the preexisting factors upon a determination that the respective preexisting factor accurately categorizes the generated control; and outputting an indication, for a second subset of the generated controls, that none of the preexisting factors accurately categorizes the generated control.

In examples, assigning a factor to each of the generated controls further includes performing the steps of: automatically inputting the second subset of the generated controls into a further LLM and generation, via the further LLM, a factor that is descriptive of the unassigned control and a description of the factor.

In examples, the method further includes automatically rephrasing the generated controls to reference a singular entity by inputting into a LLM: a data structure including the generated controls; and a data structure including example controls, a singular example entity for each example control, and rephrased example controls that are rephrasings of the example controls to reference the respective singular example entity.

In examples, the method further includes parsing a document to extract text from the document; automatically comparing the extract texted with one of the generated controls; and generating a structured string including an answer to the generated control along with a snippet of text providing the answer.

In examples, the method further includes generating citation information for the generated snippet of text.

In examples, the generating citation information for the generated snippet of text includes: creating a first structured string associating the text of the electronic rules document with location information of the text in the electronic rules document; creating a second structured string associating each of the snippets of text with the text of the electronic rules document; generating a third structured string associating each of the snippets of text with location information of the associated text in the electronic rules document by performing a string match of the text in the first structured string and the text in the second structured string.

In examples, the method further includes autogenerating a compliance score for all of the generated controls.

In examples, the autogenerating of the compliance score for all of the generated controls including inputting into a LLM a first structured string associating each of the generated controls with an ideal answer and a generated answer; the LLM compiling the compliance score by comparing each generated answer with the corresponding ideal answer and to provide a control score for each generated control.

In examples, the method further includes associating, in a first structured data object, source text of each cross-reference within the electronic rules document with the cross-reference and the location of the cross-reference within the electronic rules document.

In examples, the method further includes generating a second structured data object associating each cross-reference with the source text of each cross-reference; generating a third structured data object associating the text of the assimilated electronic rules document with location information; and generating the first structured data object by performing a string match of the source text in the first data structure and the text in the second data structure.

A non-transitory computer-readable media is also provided storing computer-executable instructions that, when executed on one or more processors, cause the one or more processors to perform the method.

A server computer system is also provided for automatically generating interactive compliance controls for a client computing system, the system including: at least one processor; and a memory coupled to the at least one processor, the memory including software modules executable by the at least one processor to: receive a first input from the client computing system, the first input providing: an electronic rules document or identifying information for the electronic rules document, the electronic rules document including a plurality of compliance rules; and information related to an asset; and output, to the client computing system and in response to the first input, controls corresponding to the compliance rules, the controls being rephrasings of the compliance rules and generated by inputting the electronic document into a first large language model (LLM), the first LLM generating the rules based on example inputs specifying acceptable and unacceptable control outputs for a plurality of compliance rule inputs.

### BRIEF DESCRIPTION OF THE DRAWINGS

The present disclosure is described below by reference to the following drawings, in which:

FIG. 1 shows a method 100 for processing an electronic regulation document to integrate cross-referenced text into the electronic regulation document.

FIG. 2 shows a method 200 for processing the modified reference-free content-assimilated regulation/policy document 110 stored in the modified document database 112 to generate and initial set of generated controls.

FIG. 3 shows a method 300 for processing the electronic regulation documents 105 from regulation database 106 and the initial set of generated controls 208 to link the initial set of generated controls 208 and to the associated source text of the and location information in the electronic regulation documents.

FIG. 4 shows a method 400 for generating ideal answers to each of the initial controls.

FIG. 5 shows a method 500 for generating factors for and assigning a factor to each of the initial controls.

FIG. 6 shows a method 600 for receiving and/or retrieving asset information and assigning asset information to each of the initial controls.

FIG. 7 shows a method 700 for receiving and/or retrieving information used to determine whether each other of the controls relates to a governed entity or a governing entity.

FIG. 8 shows a method 800 for rephrasing each of the initial controls.

FIG. 9 shows a method 900 for generating a controls answering and snippet extraction LLM 908 answering each of the asset-specific controls for the company.

FIG. 10 shows a method 1000 for generating citation information for the extracted snippets.

FIG. 11 shows a method 1100 of providing a compliance score and posture visibility for the asset-specific controls based on the controls-citation record 1026.

FIG. 12 shows a method 1200 of linking the cross-referenced text in a regulation/policy document 110 with the cross-referencing text.

FIG. 13 schematically illustrates a server computer system can utilize the technology created in the methods of FIGS. 1 to 12 to output compliance controls, compliance control and compliance scores to a user of a remote client computer, which can be a client computer within a computing infrastructure utilizing enterprise software—i.e., an enterprise software system.

### DETAILED DESCRIPTION

The system and method of the present disclosure can be embedded in any enterprise software system that requires compliance and used to prove compliance inline. The system and method of the present disclosure is applicable to, for example, acceptance or rejection of an AI/ML application at any point in time during its development, for example, the deployment time. The controls generation module of the system can generate control questions from a company policy and/or an external regulation like the EU AI Act. The document provided for a particular AI/ML application can then be processed by the question answering module to generate answers to the control questions. The document provided for a particular AI/ML application can for example be an AI solution design document, an implementation document, and/or software code that implements the AI solution with comments. Compliance posture score thus computed can inline decide acceptance or rejection of the deployment and provide visibility into any reasons for rejection.

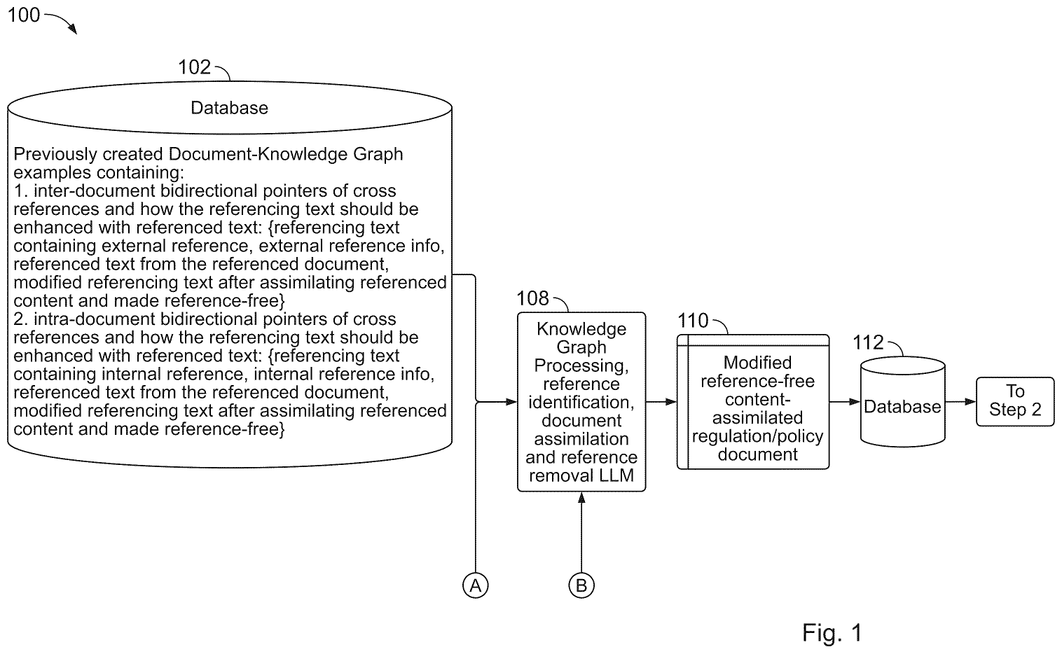

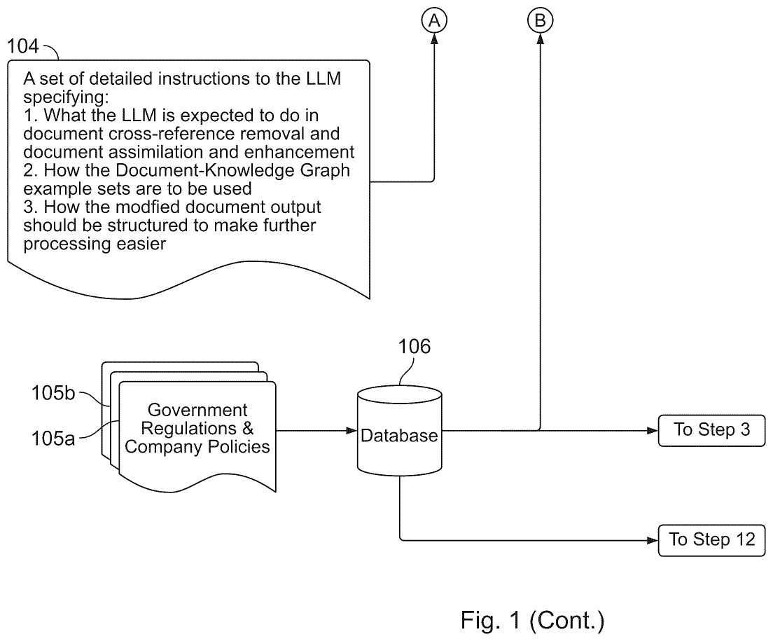

FIGS. 1 to 13 illustrate computer implemented methods that can be performed together as a single method by a server computer system to automatically process electronic rules documents into a digestible form usable by machine learning modules to generate compliance controls for the assets, while also automatically evaluating compliance with these controls within the enterprise software system comprised of software, applications and document storage. The server computer system can include at least one processor and a memory coupled to the at least one processor. The memory can include software modules executable by the at least one processor to perform the steps of methods 100 to 1300. The machine learning modules can LLMs. While the present application refers to the LLMs by different names based on the function of the LLM, or by a first LLM and a second LLM, this should not be limiting. It should be understood that a single LLM can be used for each of methods 100 to 1300 or any number of LLMs can be used. For example, the LLMs can be Open AI o3-mini, Open AI 04-mini, Open AI 03, Llama 3.2 11B Vision, and/or Llama 3.2 90B Vision. For example, Open AI o3-mini, Open AI 04-mini and/or Open AI 03 can be used when methods 100 to 1300 are performed on a cloud service accessible by client computers over a browser and Llama 3.2 11B Vision and/or Llama 3.2 90B Vision can be used when methods 100 to 1300 are performed on a private cloud in a self-hosted/on-prem mode.

FIG. 1 shows a method 100 for processing an electronic rules document to integrate cross-referenced text into the electronic regulation document. Method 100 solves the technical problem of integrating text from multiple electronic documents into a single document which allows the document to processed with instructions that allow for the controls to be generated from an entirety of the content of the electronic document by a LLM. For example, the electronic regulation document can be the EU AI Act, which cross-references out EU regulatory documents in the text of the EU AU Act. The method first includes a step of storing previously-created document-knowledge graph examples in a cross-reference knowledge graph database 102 that contains inter-document bidirectional pointers and intra-document bidirectional pointers. The inter-document bidirectional pointers link nodes representing the cross-referenced text to nodes representing the referencing text and direct how the referencing text is to be enhanced by inclusion of the cross-referenced text. Similarly, the inter-document bidirectional pointers link cross-referenced text to the referencing text and direct how the referencing text is to be enhanced by inclusion of the cross-referenced text. The enhancement automatically integrates cross-referenced content into the primary text, applying grammatical corrections and stylistic adjustments for flow and readability. Rather than inserting the cited material verbatim, the system adapts and refines it for seamless incorporation. Illustrative examples demonstrate how the incorporated text is modified-providing guidance on appropriate grammatical edits and readability improvements.

More specifically, the cross-reference knowledge graph database 102 includes two knowledge graphs for an example natural language (NL) electronic rules document. The NL electronic rules document can for example be a docx or PDF and includes text of a plurality of rules governing an assert. The text of the NL rules document also includes cross-references to different portions of the NL electronic rules document (i.e., intra-document cross-references) and/or cross-references to portions of one or more further documents (i.e., inter-document cross-references). The first knowledge graph includes a plurality of first nodes including, as content, the text of the plurality of rules and the text of the plurality of cross-references. In particular, each of the first nodes includes as content corresponding text of the plurality of rules or the text of the plurality of cross-references.

The first nodes include first base text nodes including, as content, the text of the plurality of rules and first cross-reference nodes including the text of the plurality of cross-references. Each of the first cross-reference nodes is linked to a corresponding one of the first base text nodes by two edges forming the bidirectional pointers.

The first knowledge graph also includes corresponding first metadata for the content of each of the first nodes. The first metadata includes document location information associated with the corresponding text. For example, for a first node that includes as content text from page 6, lines 10 to 12 of the NL electronic rules document, the first metadata for this first node can be page 6, lines 10 to 12. As other examples, the first meta data can include the chapter, paragraph and/or section of the NL electronic rules document.

The two knowledge graphs for the example NL electronic rules document also include a second knowledge graph. The second knowledge graph includes the same information as the first knowledge graph, except that the content and the metadata are reversed. The second nodes include as content the location information and as second metadata the text of the plurality of rules and the text of the plurality of cross-references the NL electronic rules document. It can be advantageous to have each of the first nodes include from one sentence to ten sentences of text.

The method also includes a step of generating training instructions 104 for inputting into a cross-reference integration LLM 108. The step of generating training instructions can include inputting a detailed set of instructions into the cross-reference integration LLM 108 that provide the cross-reference integration LLM 108 with instructions 104a for cross-reference removal and document assimilation and enhancement, instructions 104b for using the document-knowledge graph examples stored in the cross-reference database 102, and instructions 104c for structuring the resulting modified electronic regulation to simplify further processing.

The instructions 104a for cross-reference removal and document assimilation and enhancement includes instructions for replacing cross-references in a NL electronic rules document with the actual text that is cross-referenced. The cross-references can be intra-document cross-references referencing to different portions of the NL electronic rules document and/or inter-document cross-references referencing different portions of one or more further electronic documents. For example, the NL electronic rules document can be the Digital Operational Resilience Act (DORA) and a further electronic document can be Directive (EU) 2022/2555, which is referenced within DORA. DORA references definitions of terms that are included in Directive (EU) 2022/2555, instead of providing the actual definitions.

Cross-reference removal and document assimilation and enhancement can include parsing the main rules document to identify citations cross-referencing to one or more further rules documents, parsing the further document to identify the text of the cross-referenced citation, and extracting the text of the cross-referenced citation. The cross-reference removal and document assimilation and enhancement can also include parsing the main rules document to identify citations cross-referencing another portion of the main rules document, parsing the one or more further documents to identify the text of the referenced other portion and extracting the text of the cross-referenced citation.

The instructions 104b for using the document-knowledge graph examples stored in the cross-reference database 102 can instruct the LLM 108 to generate a plurality nodes in the same manner as the example in the cross-reference knowledge graph database 102, and directional pointers in the form of two directional edges linking each nodes including cross-reference text with a node including text from the main rules document that included the citation. In particular, the instructions can direct the LLM 108 to parse the text of the main document and the extracted cross-referenced citation, and generate nodes in same manner as the document-knowledge graph examples stored in the cross-reference database 102. The text from the main rules document and the one or more further documents can be used to generate first nodes in a first knowledge graph with the extracted text as content and the location information for the extracted text as metadata, and to generate second nodes in the second knowledge graph with the location information for the extracted text as content and the extracted text as metadata.

In particular, each node of a first knowledge graph can be generated to include as content a segment of text having a specific grammatical hierarchy defined by the examples in database 102. Grammatical hierarchy can include a number of words, a number of phrases, a number of clauses, a number of sentences or a number of paragraphs. As noted above, it can be advantageous to have each of the first nodes include from one sentence to ten sentences. For example, if each first node in database 102 includes as content two or three sentences, the instructions 104b can result in the LLM 108 generating a distinct node for each two or three sentences of the text generated by instructions 104a.

The instructions 104b can also generate metadata for each node of the first knowledge graph identifying the location of the text segment of the node within the main rules document. For the extracted text of the cross-referenced citation, the metadata can identify the location of the citation in the main rules document and/or the location of the text in the corresponding further document.

Each node of a second knowledge graph can be generated to include content as a location within the main rules and metadata can be generated for each node identifying a segment of text having the specific grammatical hierarchy defined by the examples in database 102 for the location of the respective node. As noted above, each first node of the first knowledge graph has a corresponding second node in the second knowledge graph that includes as content the metadata (e.g., location information) of the first node, and each second node has as metadata the content of the corresponding first node.

Instructions 104c for structuring the resulting modified electronic regulation to simplify further processing can include generating a further NL rules document including only the text of the first nodes and no cross-references. The bidirectional pointers in the knowledge graphs are used as instructions regarding where to insert the cross-referenced text in the further NL rules document. For example, the LLM 108 can format the content and metadata of the nodes into structured data objects, e.g., JSON objects, format the data as text, then render the text with a PDF library. Upon insertion, instructions 104c instruct the LLM 108 to integrate the cross-referenced text into the further NL rules document in a grammatically correct manner and reads naturally as guided by the examples in database 102.

The method can further include storing electronic rules documents, which can include government regulations and company policies, as one or more electronic rules documents 105 in a regulation database 106. Documents 105 include a main electronic rules document 105a and one or more further electronic rules documents 105b, which are cross-referenced in the main rules document.

The method next includes a step of performing a generative document processing operation by inputting the document-knowledge graph examples stored in the cross-reference database 102, the electronic regulation document stored in a regulation database 106 and the training instructions 104 into the trained cross-reference integration LLM 108 to output a modified reference-free content-assimilated regulation/policy document 110, which can be stored in a modified document database 112 for use in downstream operations.

Specifically, LLM 108, using the document-knowledge graph examples from database 102, can apply instructions 104a to 104c to documents 105a, 105b to replace cross-references in the electronic rules document 105a with source text of the cross-references by replacing inter-document cross-references in the main electronic rules document 105a with natural language text from one or more further electronic rules documents 105b; and/or replacing intra-document cross-references in the main electronic rules document 105a with natural language text from other portions of the electronic rules document 105b.

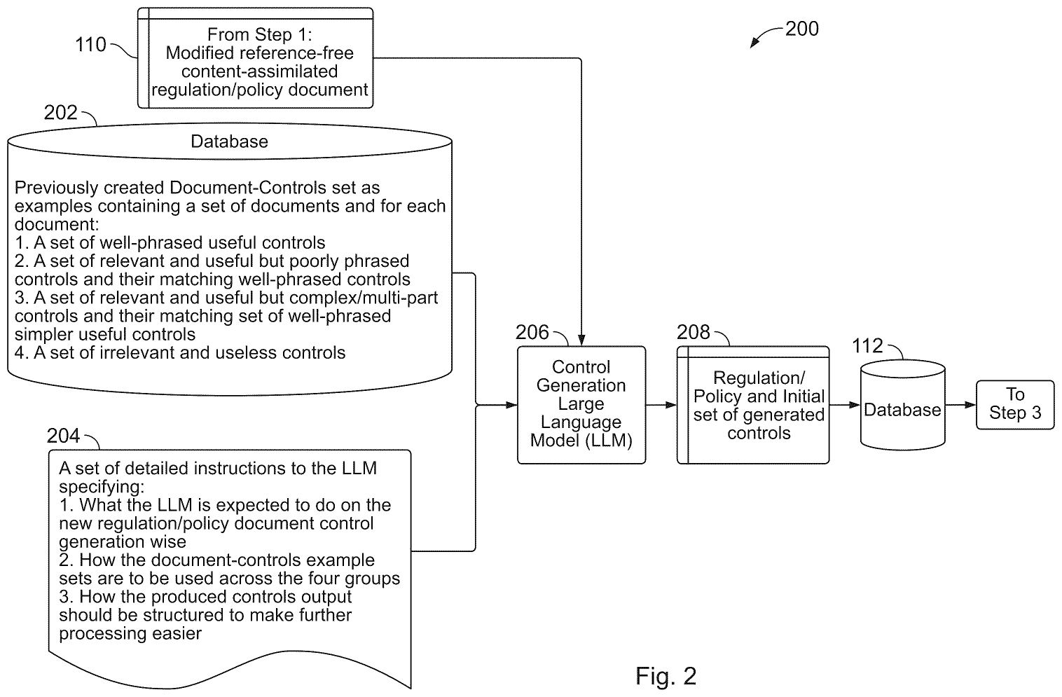

FIG. 2 shows a method 200 for processing the modified reference-free content-assimilated regulation/policy document 110 stored in the modified document database 112 to generate an initial set of generated controls. Method 200 provides LLM 206 with instructions and a data structure that include example input data objects that each include natural language associations between document text and controls defining the processing of an electronic document by the LLM 206 to generate a data structure that associates compliance controls, which are configured to illustrate compliance or non-compliance with rules within the electronic document, with the source within the electronic document in respective data objects.

The method of FIG. 2 first includes a step of storing previously-created document-controls examples in an initial controls training database 202 that contains a set of documents, and for each document, a plurality of unacceptable and acceptable examples for training an initial controls LLM 206 to output controls that are deemed acceptable.

In particular, initial controls training database 202 includes data strings, for example in a JSON file, including training examples in the form of unacceptable and acceptable examples. For example, acceptable examples are controls that are questions that are relevant to determining whether an assert is being used by an entity in a manner that complies with a government regulation or company policy and unacceptable examples are controls that are questions that are not relevant to determining whether an assert is being used by an entity in a manner that complies with a government regulation or company policy. The unacceptable examples can be unacceptable for different reasons. The data strings can be parsed and converted into structured data objects for input into a LLM 206. Each structured data object can for example be a JSON object that includes a plurality of key-value pairs, with the keys being the controls example categories and the values being the control text. The example text can be acceptable or unacceptable from an objectively definable property including for example grammatical structure, readability, specificity and/or utility.

The training examples can include (1) a set of well-phrased useful controls, (2) a set of useful but poorly-phrased controls and their matching well-phrased controls, (3) set of relevant and useful but complex/multi-part controls and their matching set of well-phrased simpler useful controls, and (4) a set of useless controls.

By “well-phrased” it is meant that the controls are grammatically correct and use specific language, while “poorly-phrased controls” are grammatically incorrect and use vague or general language. A control has utility or is useful when it helps to understand whether the asset is compliant or non-compliant with rules in the NL electronic rules document. For example, a useless control would be a question asking the title of the NL rules document. The readability of a control can be specified using a readability metric including for example the Flesch-Kincaid Grade Level metric.

The method also includes a step of generating training instructions 204 for inputting into initial controls LLM 206. The step of generating training instructions 204 can include inputting a detailed set of instructions into the initial controls LLM 206 that provides the initial controls LLM 206 with instructions 204a for processing the modified reference-free content-assimilated regulation/policy document 110 to generate controls, instructions 204b for how the document-controls examples in the initial controls training database 202 are used to generate controls, and instructions 204c for structuring the resulting controls to simplify further processing.

An example will now be discussed to illustrate how these instructions 204 can be generated for input into the initial controls LLM 206.

With respect to instructions 204a for processing the modified reference-free content-assimilated regulation/policy document 110 to generate controls can instruct the LLM 204 to generate questions asking about a current state or practice, instead of questions asking about regulatory or legal requirements. The instructions can specify that the generated controls are (1) factual, (2) actionable (e.g., “is the asset (question)?” or “does the asset (question)?”), (3) closed-end, and/or (4) yes or no questions, and (5) present tense. For example, the instructions may state:

“You are a question-generation system. You specialize in generating reliable, factual and actionable, closed-ended, yes-or-no type questions based on a given document. You generate questions only based on the given document. You do not hallucinate. You should generate questions such that they inquire about the actual practices, actions, or implementations in a specific context or scenario. I'm interested in understanding what is currently being done or carried out, rather than what is officially required or mandated. For example, the question ‘Are medicinal products for human use manufactured or imported into the Union manufactured in accordance with good manufacturing practice?’ is preferred because it is asking about the current state or practice. On the other hand, the question ‘Are medicinal products for human use manufactured or imported into the Union required to be manufactured in accordance with good manufacturing practice?’ is not preferred because it is asking about the regulatory or legal requirements seeking to understand whether there is a mandate or a legal obligation.”

With respect to instructions 204b for how the document-controls examples in the initial controls training database 202 are used to generate controls, the instructions may state:

“You will be given a JSON dictionary, described below, which contains examples for you to use while generating questions:
Each member of the dictionary is identified by the key which is the name of a document. The corresponding value is itself another dictionary defined as follows.
(a) A key-value pair identified by the key “content” has a textual value which is the content of the named document
(b) A key-value pair identified by the key “useful_and_well_formed_questions” is a list of useful and well-formed questions that can be generated from the associated document content. You should try and follow these examples when generating questions from the new document.
(c) A key-value pair identified by the key “useless_questions” is a list of example questions that can be generated from the associated document content but which are considered as useless so you should try and not generate such questions from the new document.
(d) A list of questions, which is identified by the key “simple_rephrased_questions”, each element of which has two parts: first part is a poorly formed question that can be generated from the associated document content and a corresponding second part which is a well-formed manually rephrased version of the first part. For each element of the set, the poorly formed question is identified by the key “poorly_formed_question” and the well-formed question is identified by the key “well_formed_question”. When generating questions on the new document, you should try and generate questions that read like the well-formed question instead of the corresponding poorly formed question.
(e) A set of questions, which is identified by the key “complex_rephrased_questions”, each element of which has two parts: first part is a poorly formed complex question that can be generated from the associated document content and a corresponding second part which is a set of well-formed simpler questions. For each element of the set, the poorly formed complex question is identified by the key “complex_question” and the well-formed set of simpler questions is identified by the key “simpler_questions”. When generating questions on the new document, you should try and generate questions that read like the simpler questions instead of the corresponding complex question.
   You will then be given a new document as the input. Your task is to generate closed-ended questions from it. You will use the examples in the JSON input example dictionary effectively to generate simple, well-formed questions while avoiding the generation of complex questions or useless questions. Make sure to generate a question for each point or sub-point in the document unless the generated question can be considered as useless.”

With respect to instructions 204c for structuring the resulting controls to simplify further processing can direct the LLM 206 to create a controls data record including a plurality of structured data objects that each include a control and the source of the control within the electronic rules document 105a. For example, the instructions may state:

“Your output should be in a JSON object format containing the generated question as well as the appropriate area of the document that results in the question. Here is an example of how your output should look like:
[{‘Question’: ‘Does the creditor consider any information obtained which is not used to discriminate against an applicant on a prohibited basis?’, ‘Source’: ‘§ 202.6(a)’}, {‘Question’: ‘Does the creditor take into account an applicant's age or income from public assistance while evaluating creditworthiness?’, ‘Source’: ‘§ 202.6(b)(2)’}]
Your output should contain only a valid J SON. Do not include any other comments such as ‘JSON output’, ‘Here is the JSON from the document’ etc.”

Table 1 illustrates examples of unacceptable controls in the left column, along with acceptable controls in the right column.

TABLE 1

| Unacceptable Controls | Acceptable Controls |
|---|---|
| Is it prohibited to use an AI system that deploys subliminal | Does the AI system deploy or intend to deploy subliminal techniques? |
| techniques beyond a person's consciousness or uses | Does the AI system use or intend to use manipulative or deceptive |
| manipulative or deceptive techniques? | techniques? |
| Are there exceptions to the prohibition of AI systems that | Is this AI system, deploying subliminal techniques, being used or |
| deploy subliminal techniques? | intended to be used for approved therapeutical purposes, and therefore, |
| | exempt from prohibition? |
| Is it prohibited to use an AI system that exploits the | Does this AI system exploit or intend to exploit the the vulnerabilities of a |
| vulnerabilities of a person or a specific group of persons? | person or a specific group of persons? |
| Is it prohibited to use biometric categorisation systems that | Does this AI system use biometric categorisation systems, categorising |
| categorise natural persons according to sensitive or | natural persons according to sensitive or protected attributes or |
| protected attributes or characteristics? | characteristics? |
| Are there exceptions to the prohibition of biometric | If this AI system uses biometric categorization systems, is it intended for |
| categorisation systems? | use or being used for approved therapeutical purposes on the basis of |
| | specific informed consent from participating individuals? |
| Is it prohibited to use AI systems for the social scoring | Is this AI system being used or intended to be used for social scoring |
| evaluation or classification of natural persons or groups? | evaluation or for classification of natural persons or groups? |
| Is it prohibited to use 'real-time' remote biometric | Is this AI system being used or intended to be used in remote biometric |
| identification systems in publicly accessible spaces? | identification systems in publicly accessible spaces? |
| Is it prohibited to use an AI system for making risk | Is this AI system being used or intended to be used for making risk |
| assessments of natural persons or groups in order to | assessments of natural persons or groups in order to assess the risk of a |
| assess the risk of a natural person for offending or | natural person for offending or reoffending? |
| reoffending? | Is this AI system being used or intended to be used for predicting the |
| | occurrence or reoccurrence of an actual or potential criminal or |
| | administrative offence based on profiling of a natural person? |
| Is it prohibited to use AI systems that create or expand facial | Is this AI system intended for use or being used to create or expand |
| recognition databases through the untargeted scraping of | facial recognition databases through the untargeted scraping of facial |
| facial images from the internet or CCTV footage? | images from the internet or CCTV footage? |
| Is it prohibited to use AI systems to infer emotions of a | Is this system being used or intended for use to infer emotions of a |
| natural person in the areas of law enforcement, border | natural person in the areas of law enforcement, border management, in |
| management, in workplace and education institutions? | workplace and education institutions? |

The method of FIG. 2 next includes a step of performing a generative document processing operation by inputting the document-controls examples in the initial controls training database 202, the generated training instructions 204 and the modified reference-free content-assimilated regulation/policy document 110 into the initial controls LLM 206, which outputs structured data objects including an initial set of generated controls 208, which can be stored in database 112 with bi-directional pointers to the corresponding source in the modified reference-free content-assimilated regulation/policy document 110.

A specific example of how LLM 206 may process the JSON inputs and document 110 to generate example JSON output for controls 208 with bi-directional pointers follows.

The LLM 206 may first parse the JSON input from database 202, extracting the example questions and their associated metadata. It may then tokenize and encode the text of document 110 using natural language processing techniques, establishing bi-directional pointers between the source text and the generated controls.

The LLM may utilize attention mechanisms to identify key phrases and concepts in document 110 that align with patterns seen in the training examples. For each relevant section of text, the model may generate candidate questions by applying learned templates and substituting in context-specific details, maintaining bi-directional pointers that link each question back to its source text and each source text to its corresponding questions.

These candidate questions may then be filtered and refined based on the criteria specified in the instructions, such as being factual, actionable, and in present tense. The model may leverage its language understanding capabilities to rephrase questions as needed while preserving the bi-directional pointers to maintain traceability.

For each generated question, the LLM may track the source location within document 110 using token position information and create bi-directional pointers that allow navigation from the control to its source and from the source to its associated controls. It may then format the final output as a JSON array of question-source pairs with these bi-directional relationships encoded.

An example JSON output for controls 208 with bi-directional pointers can be:

[{“Control”: “Does the AI system collect biometric data from individuals without their explicit
consent?”,
“Source”: “Article 5, Paragraph 2”,
“SourceTextPointer”: “doc110:page4:line15:char1:page4:line18:char45”,
“ControlID”: “CTL-001”,
“SourceToControlPointer”: “doc110:page4:line15:char1:page4:line18:char45->CTL-001”},
{“Control”: “Is the AI system designed to identify individuals in public spaces using real-time
facial recognition?”,
“Source”: “Article 8, Section 1(a)”,
“SourceTextPointer”: “doc110:page7:line22:char5:page7:line24:char78”,
“ControlID”: “CTL-002”,
“SourceToControlPointer”: “doc110:page7:line22:char5:page7:line24:char78->CTL-002”}]

This structured output allows for easy integration with downstream processing steps and maintains traceability back to the source regulation text. The bi-directional pointers enable navigation from controls to their source text and from source text to their associated controls. The LLM may generate dozens or hundreds of such question-source pairs with bi-directional pointers to comprehensively cover the content of document 110.

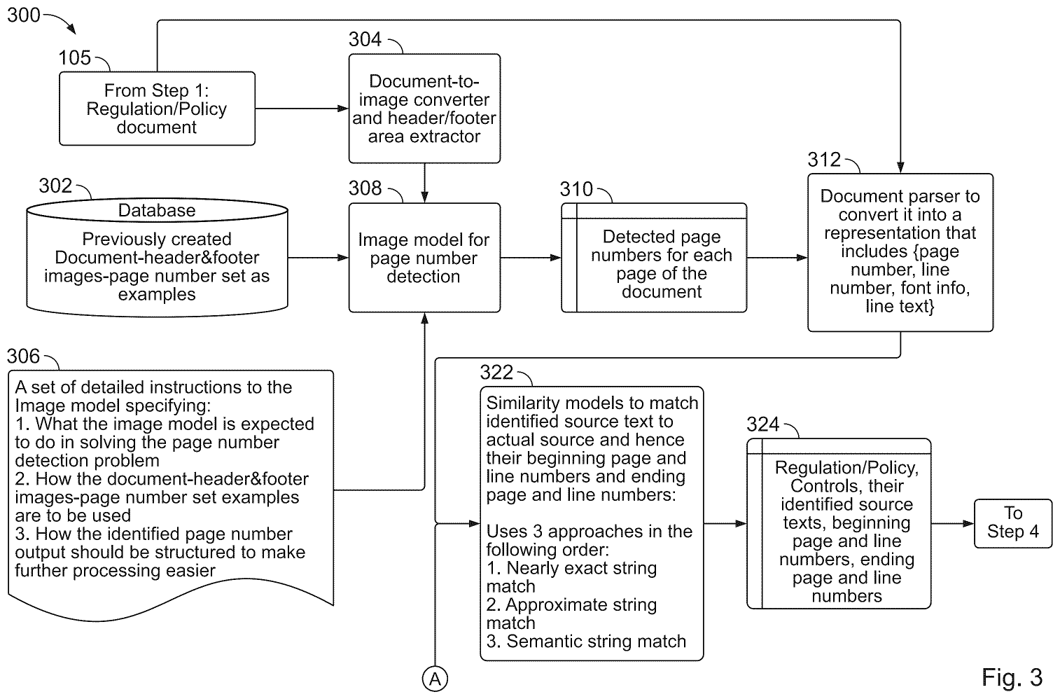

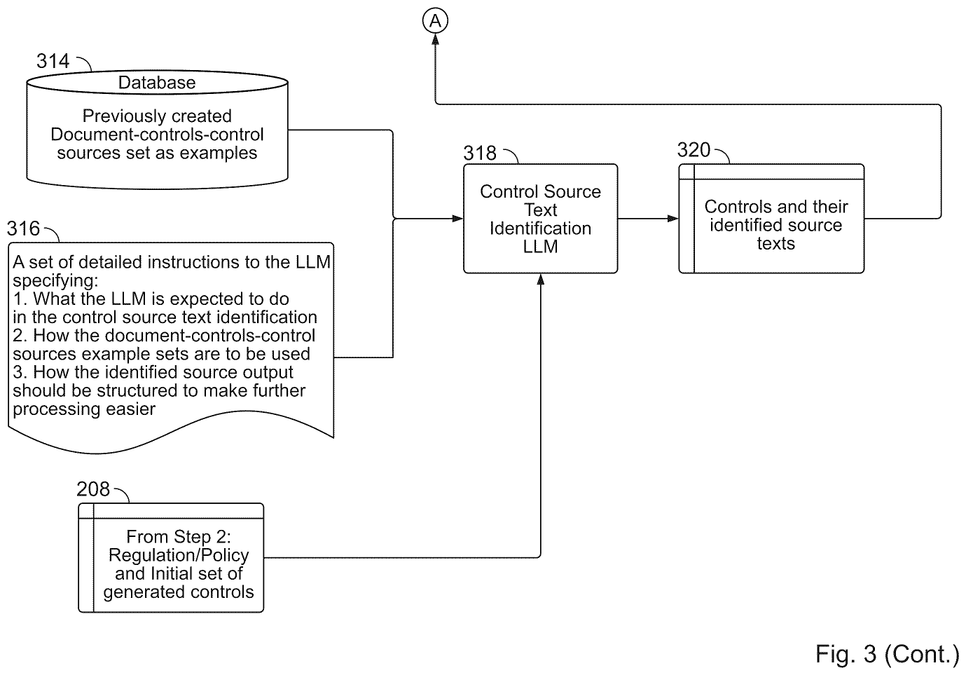

FIG. 3 shows a method 300 for processing the electronic regulation documents 105 from regulation database 106 and the initial set of generated controls 208 to link the initial set of generated controls 208 to the associated source text of and the location information in the electronic regulation documents. The linking of method 300 provide an electronic record that optimizes information retrieval and transparency.

The method 300 includes a step of storing previously-created document header and footer images page number set as examples in a header/footer database 302, and inputting the electronic regulation documents from regulation database 106 into a document-to-image converter and header/footer area extractor 304. The document header and footer images page number set includes images of the header and/or footer of the document and are used to identify the page number. The document-to-image converter can be for example commercially available Python code that converts a PDF to an image format. The document-to-image converter and header/footer area extractor 304 can crop the top and/or bottom of the resulting image and set the number of pixels at the top and bottom of each page that are extracted to identify header and footer.

The method also includes a step of generating training instructions 306 for inputting into an image model 308. The step of generating training instructions 306 can include inputting a detailed set of instructions into the image model 308 that provide the image model 308 with instructions 306a for solving the page number detection problem, instructions 306b for using the document header and footer images page number set examples stored in the header/footer database 302, and instructions 306c for structuring the identified page number output to simplify further processing.

The instructions 306a can include instructions for solving the page number detection problem by analyzing the header and footer areas of each page to identify page numbers, determining the format and location of page numbers within the document, and establishing a consistent method for extracting and recording page numbers across all pages of the electronic regulation document. These instructions direct the image model 308 to first identify the consistent positioning patterns of headers and footers across multiple pages, then detect numerical or alphanumerical sequences that follow standard page numbering formats (such as “Page X of Y”, “X”, “-X-”, or Roman numerals). The instructions also specify techniques for handling special cases such as pages with missing numbers, preliminary pages with Roman numerals followed by Arabic numerals in the main text, and documents with section-specific numbering schemes. Additionally, the instructions include parameters for optical character recognition optimization specifically tailored for detecting typeset numbers in various font styles and sizes commonly used in regulatory documents, along with validation rules to ensure extracted numbers follow a logical sequence throughout the document.

The instructions 306b can include instructions for using the document header and footer images page number set examples stored in the header/footer database 302 to train the image model 308 to identify page numbers in the header and footer areas of each page of the electronic regulation document. These instructions direct the image model 308 to analyze the visual patterns and formatting characteristics of the example header and footer images to recognize where page numbers typically appear, their font styles, sizes, and relative positions within headers and footers. The instructions can specify how to handle various page numbering formats (e.g., Arabic numerals, Roman numerals, alphanumeric codes), different positioning conventions (e.g., centered, right-aligned, left-aligned), and how to distinguish page numbers from other header/footer text elements such as document titles, section names, or dates. The training process enables the image model 308 to develop robust pattern recognition capabilities for accurately extracting page numbers across different document styles and formats.

The instructions 306c can include outputting a data structure including page numbers, line numbers, and document section identifiers in a standardized format that enables efficient retrieval and cross-referencing of document content. The data structure can be formatted as JSON objects with key-value pairs that map each detected page number to its corresponding content, metadata, and positional information within the document. This structured output facilitates downstream processing by ensuring consistent data organization and enabling programmatic access to specific document sections based on their numerical identifiers.

The method 300 then includes a step of performing a page number processing operation by inputting the document header and footer images page number set in the header/footer database 302, the document-to-image converter and header/footer area extractor 304, and the training instructions 306 into the image model 308, which outputs detected pages numbers 310 for each page of the document.

The detected pages numbers 310 and the electronic regulation document are then input into a document parser 312 that converts the electronic regulation document into a data structure, which can be an in-memory dictionary, that can include a plurality of structured data objects (e.g., JSON objects) that each include {page number, line number, font info, line text} to associate location and font info with each line of text of the document 105a.

The method 300 also includes a step of storing previously-created document-controls-control sources set, which can be a plurality of structured data strings, for example JSON strings, including an example main rules document, example controls generated from the example main rules document and the source text of the example main rules document serving as the source of the example controls. The structure data strings can each include representations of bi-directional pointers between controls and associated regulations, as examples in a control sourcing database 314.

The method 300 also includes a step of generating training instructions 316 for inputting into a control source text identification LLM 318. The step of generating training instructions 316 can include inputting a detailed set of instructions into the control source text identification LLM 318 that provide the control source text identification LLM 318 with instructions 316a for identifying the source text of each control, instructions 316b for using the document-controls-control sources set examples stored in the control sourcing database 314, and instructions 316c for structuring the identified source output to simplify further processing.

The instructions 316a for identifying the source text of each control may include detailed guidance on parsing and analyzing the content of the electronic regulation document. These instructions may direct the control source text identification LLM 318 to employ natural language processing techniques to identify key phrases, legal terminology, and regulatory language that closely aligns with the generated controls. The LLM may be instructed to consider contextual information, such as section headings, paragraph structures, and semantic relationships within the document, to accurately pinpoint the source text for each control. Additionally, the instructions may specify methods for handling complex scenarios, such as when a control is derived from multiple sections of the document or when the source text is not explicitly stated but implied through a combination of clauses.

Instructions 316b may provide detailed guidance on leveraging the document-controls-control sources set examples stored in the control sourcing database 314. These instructions may direct the LLM 318 to analyze the patterns and relationships between example controls and their corresponding source texts in the training data. The LLM may be instructed to identify common linguistic structures, semantic similarities, and contextual cues that link controls to their sources across various document types and regulatory domains. The instructions may also specify how to adapt the learned patterns to new documents and control sets, accounting for variations in document structure, terminology, and regulatory focus. This may include techniques for transfer learning and fine-tuning the model's understanding based on domain-specific nuances present in the current document being processed.

The instructions 316c for structuring the identified source output may provide specific guidelines for formatting and organizing the results of the source text identification process. These instructions may direct the LLM 318 to generate a standardized output format, such as a JSON structure, that includes the control text, its unique identifier, the identified source text, and precise location information within the document (e.g., page number, paragraph number, line range). The instructions may also specify how to handle and represent bi-directional relationships between controls and source texts, enabling efficient navigation and cross-referencing. Additionally, the instructions may include guidelines for metadata generation, such as confidence scores for each source text identification, to support quality assurance and manual review processes in downstream applications.

The method 300 then includes a step of performing a page number processing operation by inputting the document-controls-control sources set examples stored in the control sourcing database 314, the initial set of generated controls 208 from method 200, and the training instructions 316 into control source text identification LLM 318, which outputs the controls and their identified source text 320 in respective structured data objects in an in-memory dictionary.

An illustrative example of the controls and their identified source text output as JSON objects including bi-directional pointers is:

{“controls”: [{“controlId”: “CTL-001”, “controlText”: “Does the AI system use biometric data
for identification purposes?”, “sourceTextId”: “SRC-001”, “sourceToControlPointer”: “SRC-
001->CTL-001”, “controlToSourcePointer”: “CTL-001->SRC-001”},
{“controlId”: “CTL-002”, “controlText”: “Is the AI system designed to be used in high-risk
scenarios?”, “sourceTextId”: “SRC-002”, “sourceToControlPointer”: “SRC-002->CTL-002”,
“controlToSourcePointer”: “CTL-002->SRC-002”}],
“sourcesText”: [{“sourceTextId”: “SRC-001”, “text”: “The use of AI systems for biometric
identification and categorization of natural persons is prohibited, except in specific cases
explicitly authorized by law.”, “location”: {“pageNumber”: 12, “lineStart”: 15, “lineEnd”:
17},“controlId”: “CTL-001”, “sourceToControlPointer”: “SRC-001->CTL-001”,
“controlToSourcePointer”: “CTL-001->SRC-001”},
{“sourceTextId”: “SRC-002”, “text”: “High-risk AI systems shall be subject to specific
requirements and obligations to ensure their safety and compliance with fundamental rights.”,
“location”: {“pageNumber”: 18, “lineStart”: 3, “lineEnd”: 5}, “controlld”: “CTL-002”,
“sourceToControlPointer”: “SRC-002->CTL-002”, “controlToSourcePointer”: “CTL-002->SRC-
002”}]}

In this example, the bi-directional pointers are represented by the “sourceToControlPointer” and “controlToSourcePointer” fields in both the “controls” and “sourcesText” arrays. These pointers allow for efficient navigation between controls and their corresponding source texts, enabling quick cross-referencing and traceability in both directions.

The data structure generated by parser 312 and the data structure 320 including the controls and their identified source text are then input into similarity models 322 that match the identified source text to actual source and hence their beginning page and line numbers and ending page and line numbers. The similarity models 322 use three approaches in the following order: (1) an exact or nearly exact string match (90-100% string match) is first attempted, then (2) an approximate string match (70-90% string match) is attempted if (1) is unsuccessful, and (3) a semantic string match is performed if (2) is unsuccessful. The similarity models 322 outputs a controls-citation record 324 that can be a data structure, for example an in-memory dictionary of JSON objects, including a plurality of structured data objects that each includes the name of the regulation/policy, one of the controls, the identified source text of the respective control, beginning page and line number of the identified source texts, ending page and line number of the identified source texts.

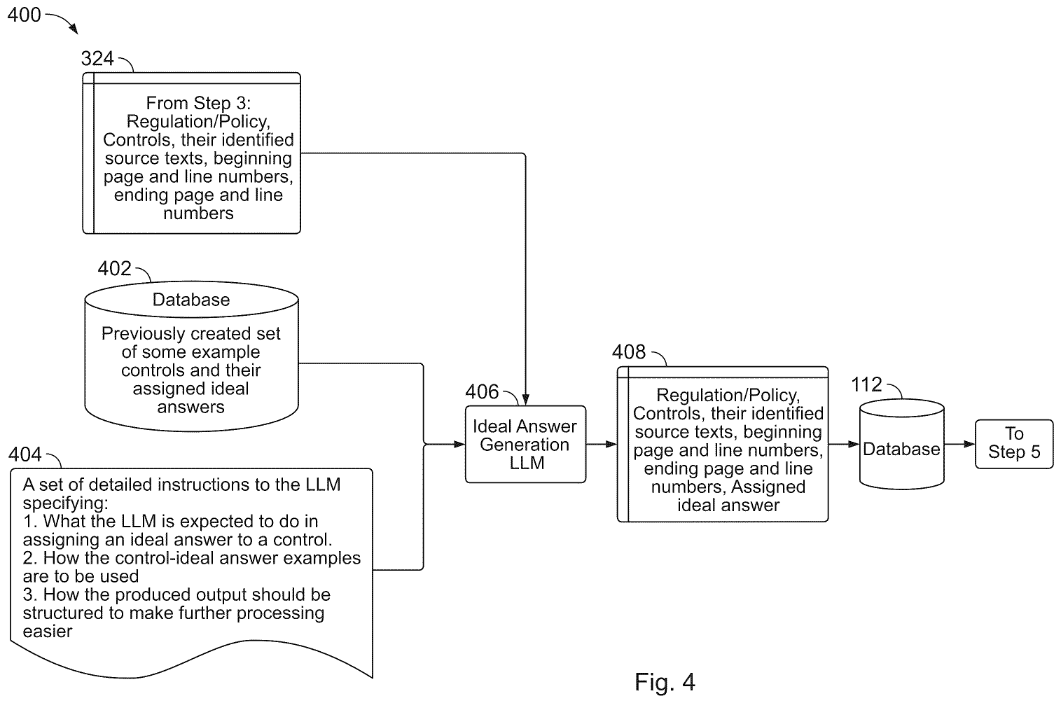

FIG. 4 shows a method 400 for generating ideal answers to each of the initial controls. The method 400 includes a step of storing previously-created example controls and their assigned ideal answers in an example answer database 402. The ideal answers indicate that the asset is in compliance with the rules of the electronic rules document.

The method also includes a step of generating training instructions 404 for inputting into an ideal answer generation LLM 406. The step of generating training instructions 404 can include inputting a detailed set of instructions into the ideal answer generation LLC 406 that provide the ideal answer generation LLM 406 with instructions 406a for assigning and ideal answer to a control, instructions 406b for using the assigned ideal answers stored in example answer database 410, and instructions 406c for structuring the ideal answer output to simplify further processing.

The method 400 then includes a step of performing an ideal answer generation operation by inputting the controls-citation record 324, the data structure in the example answer database 402 including example questions and for each example question an example ideal answer indicating an assert complies with a rule, and the training instructions 404 into ideal answer generation LLM 406, which integrates the ideal answer for each control into the controls-citation record 324 to generate a controls-citation-answer record 408 in a database 410. The answer record 408 can be a data structure including a plurality of structured data strings, each including one of the controls and the corresponding ideal answer generated by LLM 406.

An example will now be discussed to illustrate how these instructions 404 can be generated for input into the ideal answer generation LLM 406.

With respect to instructions 406a for assigning and ideal answer to a control, the instructions may state:

“You will be given a set of questions as a JSON list that will, for example, look like [“Question text 1?”, Question text 2?”]
1. Under the normative belief that all systems and processes should be well-behaved, socially responsible, unbiased, must do the right thing etc., your task is to produce the ideal answer to each question.
2. For each question, your answer should be a Yes or No. Your output should be a JSON list containing the ideal answer to each question that, for example, looks like [“Yes”, “No”].
3. The size of the output list should be the same as the size of the input JSON list.”

Instructions 406a for assigning an ideal answer to a control provide a structured approach for generating binary (Yes/No) responses to a set of questions. The instructions 406a specify the input format as a data structure containing question texts, and the output format as a data structure including structured data objects each containing a question text and the ideal answer of “Yes” or “No.” The instructions 406a specify that responses should align with normative principles of well-behaved, socially responsible, and unbiased systems and processes to produce ideal answers that represent compliance with ethical and responsible practices in asset design and operation. This methodology enables consistent and standardized ideal answer generation for compliance controls, facilitating further processing and analysis within the larger compliance assessment framework.

With respect to instructions 406b for using the assigned ideal answers stored in example answer database 410, the instructions may state:

“Here are some Question-Ideal Answer pairs for you to use as examples. You will use these examples and learn the inherent relation that exists between the question and ideal answer. You will then apply that knowledge on the new questions and produce the ideal answer for each of the questions.

### “Question”, “Ideal Answer”

“Does the AI system use subliminal techniques?”, “No”
“Does the system use protected attributes?”, “No”
“Is the AI system tested for bias?”, “Yes”
“Is proper documentations available for appropriate authorities as needed?”, “Yes”
“Is the AI system classified as a High Risk AI System as per Article 6(1) or Article 6(2) of EU AI Act?”,“No””

The instructions 406b specify using the example question-ideal answer pairs serve as training data for the ideal answer generation LLM. These examples illustrate the expected relationship between compliance-related questions and their normative, ethically aligned responses. These examples may help the LLM learn to interpret the intent and implications of compliance-related questions, recognize key phrases and concepts that indicate ethical or unethical practices, generate consistent binary (Yes/No) responses aligned with regulatory expectations and apply normative judgments across various assets. The LLM may use these examples to extrapolate patterns and generate ideal answers for new, unseen questions by identifying similarities in structure, content, and ethical implications. This approach allows for scalable and consistent ideal answer generation across a wide range of compliance controls.

With respect to instructions 406c for structuring the ideal answer output to simplify further processing, the instructions may state:

“Your output should be a JSON list of strings containing the ideal answer to each question in the
input JSON list. Do not include any other comments such as ″JSON output″, ″Here is the JSON″
etc.”

Instructions 406c specify that controls-citation-answer record 408 is a data structure including each control and the corresponding ideal answer as a data string is to output by LLM 406 for storing in database 112.

Table 2 illustrates examples of questions in the left column, along with an associated ideal answer in the right column:

TABLE 2

| Question | Ideal Answer |
|---|---|
| Does the AI system use subliminal techniques? | No |
| Does the system use protected attributes? | No |
| Is the AI system tested for bias? | Yes |
| Is proper documentations available for appropriate | Yes |
| authorities as needed? | |
| Is the AI system classified as a High Risk AI System | No |
| as per Article 6(1) or Article 6(2) of EU AI Act? | |

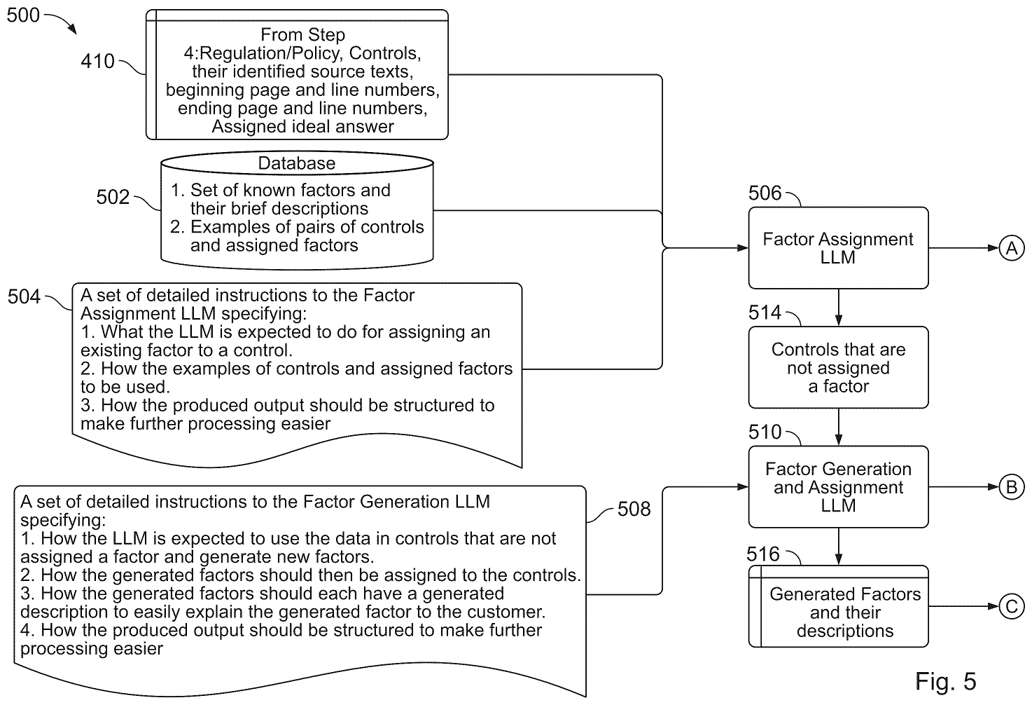

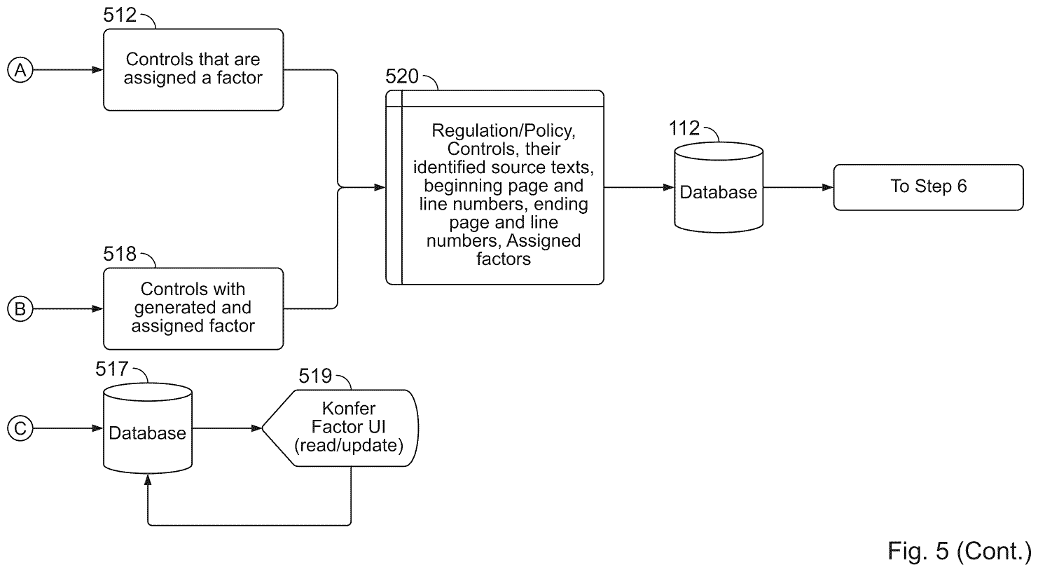

FIG. 5 shows a method 500 for generating factors for and assigning a factor to each of the initial controls. The factors categorize each generated control according to topics covered by the generated controls The method 500 includes a step of storing previously-created example factors including (1) a set of known factors and their brief descriptions, and (2) examples of pairs of controls and their assigned factors in an example factors database 502. Factors categorize controls related to a same specific topic together.

For example, if the regulation is related to AI/ML models, the factors can be those shown below in Table 3, which also provides exemplary descriptions of the factors.

TABLE 3

| Factor | Description |
|---|---|
| Fairness | In the context of artificial intelligence, this term refers to the unbiased treatment of all individuals or groups by a system, |
| | ensuring that its outputs do not discriminate against any particular demographic. It involves careful consideration and |
| | mitigation of biases that may exist in the training data, algorithms, or model interpretations. Ensuring this requires ongoing |
| | evaluation and adjustment of systems, as well as the inclusion of diverse and representative data sets. |
| Transparency | This quality in AI systems pertains to the clear, understandable, and accessible nature of the algorithms, data processes, |
| | and decision-making mechanisms employed. It involves making the workings of the system open to inspection and |
| | verification, which is crucial for building trust among users and stakeholders. This can also facilitate the identification and |
| | correction of errors or biases, promoting accountability and ethical practices. |
| Explainability | This concept refers to the ability of an AI system to provide understandable and interpretable descriptions of its processes, |
| | decisions, or outputs. It is crucial for end-users and stakeholders to trust and effectively interact with the system, especially |
| | in critical applications such as healthcare, finance, or legal contexts. It involves creating models that are interpretable by |
| | design or developing tools that can translate complex model decisions into a form that is accessible to humans. |
| Accountability | In AI systems, this refers to the establishment of clear lines of responsibility and oversight for the development, |
| and | deployment, and outcomes of the systems. It involves implementing policies, standards, and practices to ensure that the |
| Governance | systems operate ethically, transparently, and in accordance with legal and regulatory requirements. This also includes |
| | mechanisms for redress or correction in cases where the system's outputs or actions lead to adverse effects. |
| Robustness | This pertains to the ability of AI systems to perform consistently and accurately under varying conditions and to handle |
| and Reliability | unexpected or adversarial inputs gracefully. It involves rigorous testing, validation, and continuous monitoring to ensure |
| | the system's performance and integrity over time. Ensuring this quality is crucial, especially in critical applications where |
| | failures or errors can have significant consequences. |
| Privacy | In the realm of AI, this aspect focuses on protecting the personal and sensitive information used by or generated by the |
| | system. It involves implementing strict access controls, encryption, and anonymization techniques to ensure that individual |
| | data is not disclosed or misused. Ensuring this is critical for building trust among users and for complying with legal and |
| | regulatory requirements related to data protection. |
| Security | In AI systems, this aspect involves implementing measures to protect the system, its data, and its outputs from |
| | unauthorized access, manipulation, or attacks. It requires a comprehensive approach, including secure coding practices, |
| | vulnerability assessments, and the use of robust authentication and authorization mechanisms. Ensuring this quality is |
| | essential to maintain the integrity and trustworthiness of the system. |
| Safety | This refers to the ability of AI systems to operate without causing harm to humans or the environment. It involves |
| | implementing safeguards, monitoring systems, and fail-safe mechanisms to prevent or mitigate the impact of failures or |
| | errors. Ensuring this is especially critical in autonomous systems or in applications where the AI system interacts directly |
| | with the physical world. |
| Human | This aspect of AI systems involves ensuring that there are mechanisms for human intervention, supervision, or decision- |
| Oversight | making, especially in critical or sensitive contexts. It is about striking the right balance between automating tasks and |
| | maintaining human control, ensuring that the system's outputs align with human values and ethical standards. This is |
| | crucial for building trust, ensuring accountability, and mitigating the risks associated with automated decision-making. |

For example, if the regulation is the Digital Operational Resilience Act (DORA), the factors can be those shown below in Table 3, which also provides exemplary descriptions of the factors.

| Factor | Description |
|---|---|
| Cyber Threat | Cyber Threat Classification involves categorizing cyber threats based on the criticality of services at risk, the number and |
| Classification | relevance of targeted clients or financial counterparts, and the geographical spread of the areas at risk. |
| Cyber Threat | Cyber Threat Materiality Threshold determines the significance of cyber threats using high materiality thresholds and |
| Materiality | includes these thresholds in reporting criteria for major operational or security payment-related incidents. |
| Threshold | |
| ICT Incident | ICT Incident Classification entails categorizing ICT-related incidents by evaluating data losses, service criticality, and |
| Classification | establishing criteria for major incidents in consultation with regulatory bodies. |
| ICT Incident | ICT Incident Impact Assessment assesses the impact of ICT-related incidents by considering factors such as client relevance, |
| Impact | transaction volume, service downtime, geographical spread, reputational impact, and economic consequences. |
| Assessment | |
| ICT Incident | ICT Incident Reporting Criteria focuses on the application of criteria for assessing and sharing reports of major ICT-related |
| Reporting | incidents with competent authorities across Member States. |
| Criteria | |
| Regulatory | Regulatory Technical Standards Adoption involves the ESA submitting common draft regulatory technical standards to the |
| Technical | Commission and the Commission's authorization to adopt these standards using established EU regulations. |
| Standards | |
| Adoption | |
| Regulatory | Regulatory Technical Standards Development is the process where the ESA, in consultation with the ECB and ENISA, |
| Technical | develops common draft regulatory technical standards, considering criteria for major ICT-related incidents. |
| Standards | |
| Development | |
| Resource and | Resource and Capability Consideration for SMEs ensures that the ESA takes into account the specific resource and |
| Capability | capability needs of microenterprises and small and medium-sized enterprises when managing ICT-related incidents. |
| Consideration | |
| for SMEs | |
| Standards | Standards and Guidance Consideration ensures that the ESA considers international standards, guidance, and specifications |
| and Guidance | developed by ENISA during the development of common draft regulatory technical standards. |
| Consideration | |

The method also includes a step of generating factor assignment instructions 504 for inputting into a factor assignment LLM 506. The step of generating factor assignment instructions 504 can include inputting a detailed set of instructions into the factor assignment LLM 506 that provide the factor assignment LLM 506 with instructions 504a for assigning an existing factor to a control, instructions 504b for using examples of controls and assigned stored in example factors database 502, and instructions 504c for structuring the output into a data structure including a plurality of structured data objects, each including one of the controls and a corresponding factor, to simplify further processing.

Instructions 504a for assigning an existing factor to a control may direct the factor assignment LLM 506 to analyze the content and context of each control, identifying key terms, concepts, and themes that align with the predefined factors. The LLM 506 may be instructed to use natural language processing techniques to extract relevant features from the control text, such as subject matter, regulatory focus, and operational implications. These features may then be compared against the descriptions and characteristics of existing factors to determine the most appropriate match.

Instructions 504b for using examples of controls and assigned factors stored in example factors database 502 may guide the LLM 506 to leverage a machine learning approach for factor assignment. The LLM 506 may be trained on the examples to recognize patterns and relationships between control text and assigned factors. This training process may involve techniques such as text embedding, semantic similarity analysis, and supervised learning algorithms. The LLM 506 may be instructed to use these learned patterns to inform its decision-making when assigning factors to new, unseen controls.

Instructions 504c for structuring the factor assignment output may specify a standardized format for the LLM 506 to present its results. This format may include a JSON structure with fields for the control text and assigned factor.

The method also includes a step of generating new factor instructions 508 for inputting into a factor creation LLM 510. The step of generating new factor instructions 508 can include inputting a detailed set of instructions into the factor creation LLM 510 that provide the factor creation LLM 510 with instructions 508a for using the data in controls that are not assigned a factor and generating new factors, instructions 508b for assigning one of the new factors to a control, instructions 508c for generating a description for each of the new factors to easily explain the generated new factor to the customer, and instructions 508d for structuring the new factor and corresponding description output to simplify further processing.

The method 500 then includes a step of assigning a factor to each control by inputting the controls-citation-answer record 408, the example factors in the factors database 502, and the factor assignment instructions 504 into factor assignment LLM 506, which analyzes each control in controls-citation-answer record 408 using the example factors in the factors database 502 and the factor assignment instructions 504 to determine if any of the existing factors correlate to the control. LLM 506 can compare each of the generated controls to preexisting factors, a description of each preexisting factor and preexisting controls that are assigned to each factor, and generate a factor categorization for a first subset of the generated controls by assigning each of the generated controls of the first subset a respective one of the preexisting factors upon a determination that the respective preexisting factor accurately categorizes the generated control. LLM 506 can outputting an indication, for a second subset of the generated controls, that none of the preexisting factors accurately categorizes the generated control.

Upon a determination that one of the existing factors correlates to the control, factor assignment LLM 506 outputs an assigned factor-control record 512, in the form of a data structure including structured data objects each including one of the controls and and the assigned factor to the control. The factor description can be linked to the factor via a bi-directional pointer. Upon a determination that none of the existing factors correlates to the control, factor assignment LLM 506 outputs the unassigned control 514 for processing by the factor creation LLM 510.

The method 500 then includes a step of creating a factor for each unassigned control 514 by inputting the unassigned control 514 and the new factor instructions 508 into factor creation LLM 510 which analyzes each unassigned control 514 using the new factor instructions 508 to generate a factor that is descriptive of the unassigned control 514 and a description of the factor. Factor creation LLM 510 outputs the generated factors and their descriptions 516 for storing in the factors database 517, and also an assigned factor-control record 518 linking each of the controls with the generated factor. The factors in factors database 517 can then be displayed on an interactive factor GUI 519 that allows a user to read and provide feedback to modify the factors in database 517.

The assigned factor-control records 512, 518 and then input into the corresponding controls-citation-answer record 408 in database 112 to generate a factor assigned data record 520 including the controls, regulations, citation information and the assigned factor.

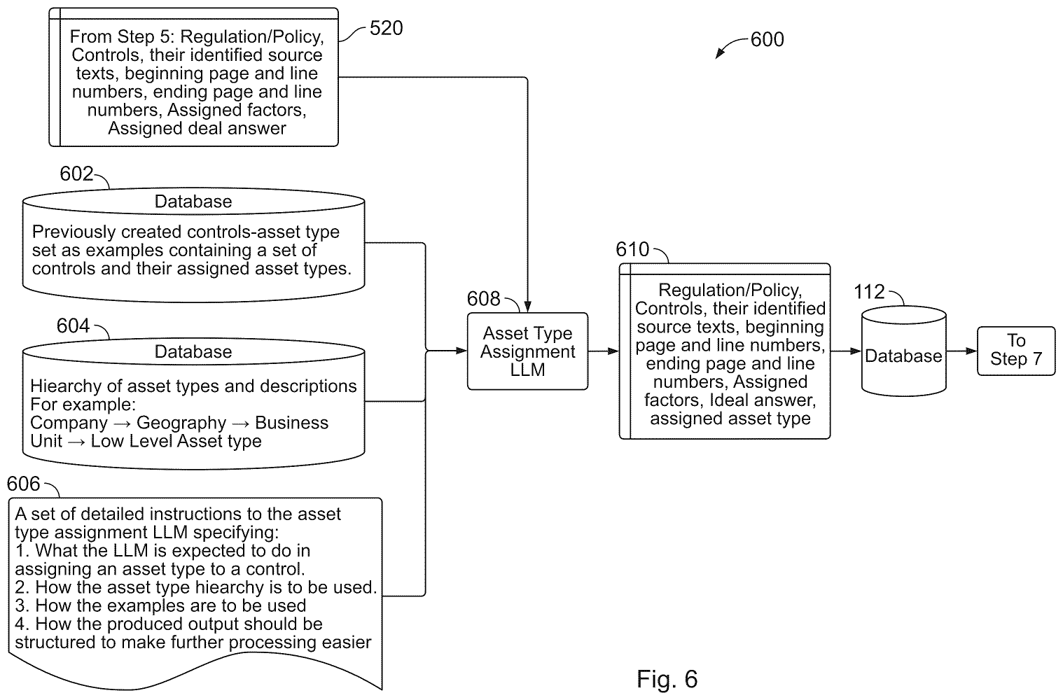

FIG. 6 shows a method 600 for receiving and/or retrieving asset information and assigning asset information to each of the initial controls. The method 600 includes a step of accessing previously-created controls-asset type set in an asset examples database 602 as examples containing a set of controls and their assigned asset types. An asset type is metadata, and asset is actual data. For example asset type is a bank, while an asset is specific bank.

The method 600 includes a step of accessing a hierarchy of asset types and descriptions of the asset types in an asset hierarchy and description database 604. The hierarchy can have multiple levels, including the company, geography, business unit and low level. The hierarchy can be defined by a customer company and can reflect the internal organizational structure of the company.

The method also includes a step of generating asset information assignment instructions 606 for inputting into an asset assignment LLM 608. The step of generating asset assignment instructions 606 can include inputting a detailed set of instructions into the asset assignment LLM 608 that provide the asset assignment LLM 608 with instructions 608a for assigning an existing asset type to a control, instructions 608b for using the asset type hierarchy, which can change on a customer by customer basis, in asset hierarchy and description database 604, instructions 608c for using controls-asset type set examples in asset examples database 602, and instructions 608d for structuring the assigned asset information output into a data structure including a plurality of data strings (e.g., JSON strings), each data string including the controls, their identified source texts, beginning page and line numbers, ending page and line numbers, assigned factors, ideal answer and assigned asset type, to simplify further processing.

The method 600 then includes a step of assigning asset information to each control by inputting the factor assigned data record 520, the asset examples in asset examples database 602, and the asset type hierarchy in asset hierarchy and description database 604 and the asset assignment instructions 606 into an asset information assignment LLM 608, which analyzes each control in factor assigned data record 520 using the asset examples in asset examples database 602, the asset type hierarchy in asset hierarchy and description database 604 and the asset assignment instructions 606 to identify the asset information for each of the controls. Upon a determination of the asset information for each of the controls, asset information assignment LLM 608 outputs an assigned asset-control associations into the factor assigned data record 520 to generate an asset assigned data record 610, which includes the controls, regulations, citation information, the assigned factor and the assigned asset information, in the database 110.

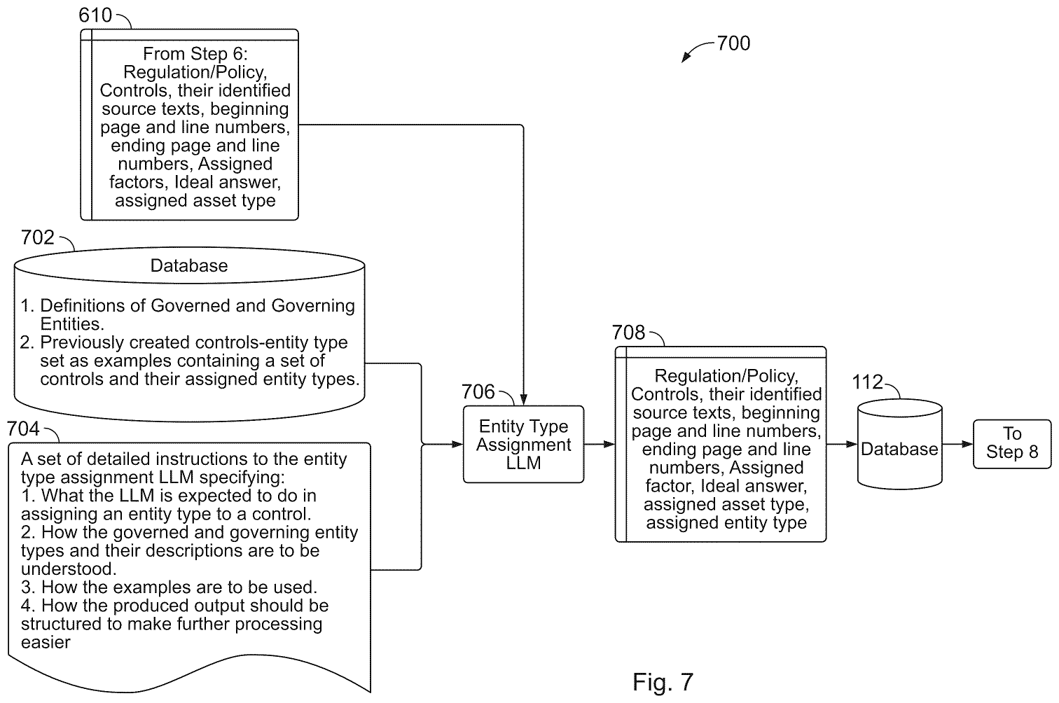

FIG. 7 shows a method 700 for receiving and/or retrieving information used to determine whether each other of the controls relates to a governed entity or a governing entity. A governed entity is an entity that is governed by a regulation or policy (e.g., a business governed by state law) and a governing entity is an entity that dictated with governing the governed entity (e.g., a state or a municipality). The method 700 includes a step of accessing previously-created entity information database 702 including (1) definitions of governed and governing entities, and (2) previously created controls-entity type set as examples containing a set of controls and their assigned entity types.

The method also includes a step of generating entity assignment instructions 704 for inputting into an entity assignment LLM 706. The step of entity assignment instructions 704 can include inputting a detailed set of instructions into the entity assignment LLM 706 that provide the entity assignment LLM 706 with instructions 704a for assigning an entity type (governed or governing) to a control, instructions 704b for how the governed and governing entity types and their descriptions are to be used, instructions 704c for using controls-entity type set examples in entity information database 702, and instructions 704d for structuring the assigned asset information output into a data structure including a plurality of data strings (e.g., JSON strings), each data string including the controls, their identified source texts, beginning page and line numbers, ending page and line numbers, assigned factors, ideal answer, assigned asset type and assigned entity type, to simplify further processing.

The method 700 then includes a step of assigning entity information to each control by inputting the asset assigned data record 610, the entity information in entity information database 702, and entity assignment instructions 704 into the entity assignment LLM 706, which analyzes each control in asset assigned data record 610 using the entity information in entity information database 702, and entity assignment instructions 704 to identify the entity information for each of the controls. Upon a determination of the entity information for each of the controls, entity assignment LLM 706 outputs an assigned entity-control associations into the entity assigned data record 708 to generate an entity assigned data record 708, which includes the controls, regulations, citation information, the assigned factor, the assigned asset information and the assigned entity information, in database 112.

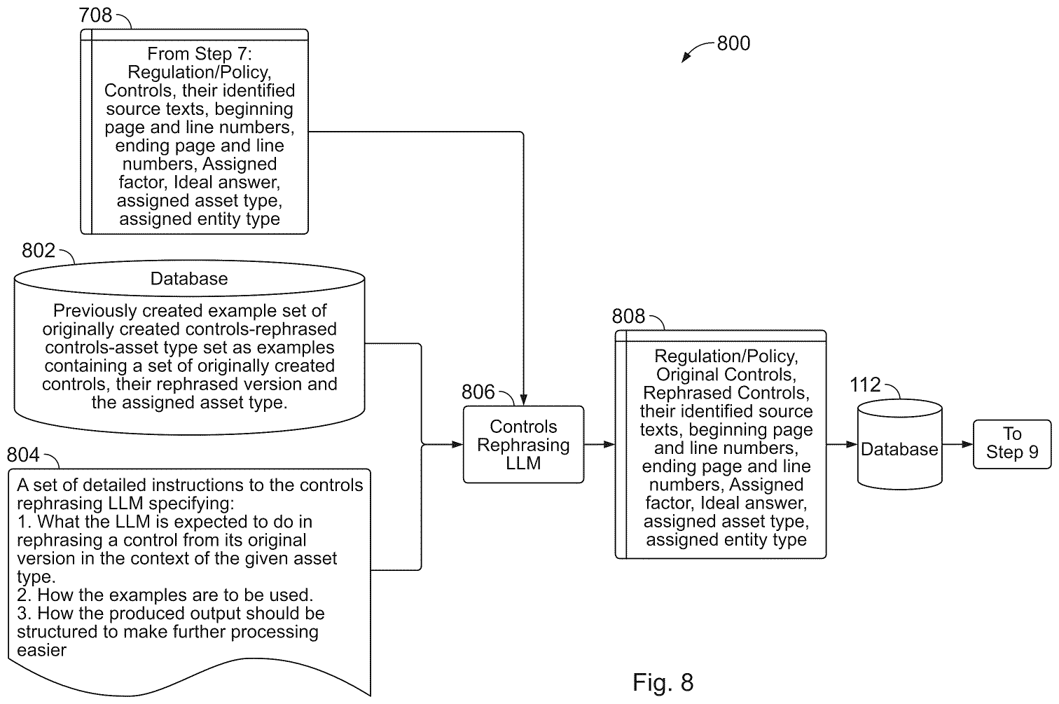

FIG. 8 shows a method 800 for rephrasing each of the initial controls. The method 800 includes a step of accessing previously-created asset-specific rephrased controls database 802 including an example set of originally created controls-rephrased controls-asset type set as examples containing a set of originally created controls, their rephrased version and the assigned asset type. In other words, database 802 includes a data structure including data strings each including example controls, a singular example entity for each example control, and rephrased example controls that are rephrasings of the example controls to reference the respective singular example entity.

The method also includes a step of generating asset-specific control rephrasing instructions 804 for inputting into a controls rephrasing LLM 806. The step of generating asset-specific control rephrasing instructions 804 can include inputting a detailed set of instructions into the controls rephrasing LLM 806 that provide the controls rephrasing LLM 806 with instructions 804a for rephrasing a control from its initial version in the context of the given asset type, instructions 804b for using example set of originally created controls-rephrased controls-asset type set in the asset-specific rephrased controls database 802, and instructions 804c for structuring the assigned asset information output to simplify further processing.

An example will now be discussed to illustrate how these instructions 804 can be generated for input into the controls rephrasing LLM 806.

With respect to instructions 804a for rephrasing a control from its initial version in the context of the given asset type, the instructions may state:

“You are a question rephrasing assistant. You do not hallucinate. You will be given a list of special entities, also known as assets, as the first input. You will also be given a list of questions-source pairs as the second input. The questions in the second input are already almost correctly phrased. Your only task to rephrase the questions such that they are asked from the point of view of a singular special entity where the special entity is identified from the given list of special entities. If multiple types of entities are included in the original question, the rephrased question should be in the form of a combination of one or more singular special entities from the list and other non-special entities being in the plural. Your output should be a JSON object having an equivalent list of rephrased question-source pairs. You should follow the steps below during the rephrasing:
a. For a given question, using the question text, identify the applicable subset of special entities from list of special entities.
b. Then check if the question requires rephrasing: a question does not require rephrasing if it already phrased correctly, which is the case, if the question is asked from the point of view of one or more singular special entities or a combination of one or more singular special entities and other non-special entities in the plural.
c. If a question does require rephrasing, then you should rephrase the question such that the rephrased question is asked from the point of view of one or more singular special entities or a combination of one or more singular special entities and other non-special entities in the plural.
d. Besides the plural-to-singular rephrasing indicated above, you should not make any other changes to the question.”

Instructions 804a can direct the rephrasing of a control by specifying the analysis of the question text to identify applicable special entities from the example list, then the evaluation of whether rephrasing is necessary by checking if the control is already correctly phrased from the perspective of one or more singular special entities, or a combination of singular special entities and plural non-special entities. If rephrasing is required, the LLM 806 is instructed to modify the control to address the control from the viewpoint of one or more singular special entities, or a combination of singular special entities and plural non-special entities. The rephrasing process focuses solely on adjusting entity plurality, maintaining all other aspects of the original question unchanged. The system can generates a data structure including structured data objects (e.g., JSON objects) as output, each containing the rephrased controls and the original controls and other content in a data record 808.

With respect to instructions 804b for using example set of originally created controls-rephrased controls-asset type set in the asset-specific rephrased controls database 802, the instructions may state:

“Here are a set of examples made of Original Question-Special Entity-Rephrased Question for you to use. You will use these examples effectively and learn the inherent relation that exists between these values. You will then apply that knowledge to the new question and the given list of special entities and produce a rephrased question for each of the questions.

### “Original Question”, “Special Entity”, “Rephrased Question”

“Are the medicinal products for human use manufactured or imported into the Union manufactured in accordance with good manufacturing practice?”, “Medicinal product”, “Is the medicinal product for human use manufactured or imported into the Union manufactured in accordance with good manufacturing practice?”
“Do manufacturers and marketing authorisation holders cooperate to comply with good manufacturing practice principles and guidelines?”, “Manufacturer”, “Do the manufacturer and marketing authorisation holders cooperate to comply with good manufacturing practice principles and guidelines?”
“Do corporations, other than microenterprises, report the environmental impact of their operations on an annual basis?”, “Corporation”, “Does the corporation, if it is not a microenterprise, report the environmental impact of its operations on an annual basis?””

With respect to instructions 804c for structuring the assigned asset information output to simplify further processing, the instructions may state:

“Your output should be a JSON list of strings containing the ideal answer to each question in the
input JSON list. Do not include any other comments such as ″JSON output″, ″Here is the JSON″
etc.”

Table 3 illustrates examples of questions in the left column, along with an associated rephrased question in the right column:

TABLE 3

| | Special | |
|---|---|---|
| Original Question | Entity/Asset | Rephrased Question |
| Are the medicinal products for | Medicinal | Is the medicinal product for human |
| human use manufactured or | product | use manufactured or imported into |
| imported into the Union | | the Union manufactured in |
| manufactured in accordance with | | accordance with good manufacturing |
| good manufacturing practice? | | practice? |
| Do manufacturers and marketing | Manufacturer | Do the manufacturer and marketing |
| authorisation holders cooperate to | | authorisation holders cooperate to |
| comply with good manufacturing | | comply with good manufacturing |
| practice principles and guidelines? | | practice principles and guidelines? |
| Do corporations, other than | Corporation | Does the corporation, if it is not a |
| microenterprises, report the | | microenterprise, report the |
| environmental impact of their | | environmental impact of its |
| operations on an annual basis? | | operations on an annual basis? |
| Do the plants train their | Plant | Does the plant train its |
| manufacturing personnel in good | | manufacturing personnel in good |
| manufacturing practice principles at | | manufacturing practice principles at |
| least once a year? | | least once a year? |
| Do the financial entities estimate the | Financial | Does the financial entity estimate the |
| numbers of clients, financial | entity | numbers of clients, financial |
| counterparts, or transactions | | counterparts, or transactions |
| impacted based on data from | | impacted based on data from |
| comparable reference periods when | | comparable reference periods when |
| actual numbers cannot be | | actual numbers cannot be |
| determined? | | determined? |

The method 800 then includes a step of rephrasing each of the initial controls by inputting the entity assigned data record 708, the example set of originally created controls-rephrased controls-asset type set of the asset-specific rephrased controls database 802 and the asset-specific control rephrasing instructions 804 into the controls rephrasing LLM 806, which analyzes each control in entity assigned data record 708 using the examples in the asset-specific rephrased controls database 802, and asset-specific control rephrasing instructions 804 to rephrase the controls in a manner that uses language addressing the asset. The controls rephrasing LLM 806 outputs the asset-specific controls into the entity assigned data record 708 to generate an asset-specific controls data record 808, a data structure including a plurality of data strings (e.g., JSON strings), each data string including the initial controls, the asset-specific controls, regulations, citation information, the assigned factor, the assigned asset information and the assigned entity information, in database 112.

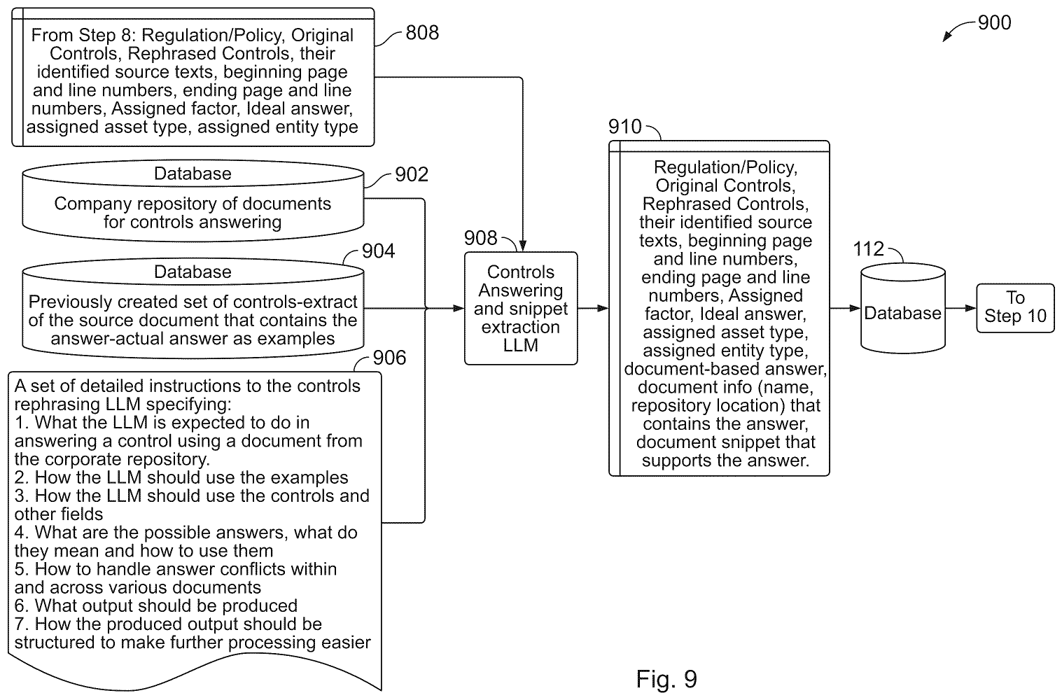

FIG. 9 shows a method 900 for generating a controls answering and snippet extraction LLM 908 answering each of the asset-specific controls for the company. The method 900 includes a step of accessing a company repository 902 of a company using the asset. The company repository 902 includes documents related to the asset. For example, if the asset is a commercially available AI model, the company repository 902 can include all of the documentation related to the use of the AI model on a cloud server. The retrieval of method 900 optimizes answer-generation accuracy and transparency.

The method 900 also includes a step of accessing previously-created controls answering database 904 including a set of controls-extract of the source document that contains the answer-actual answer as examples.

The method also includes a step of generating asset-specific controls answering and snippet extraction instructions 906 for inputting into a controls answering and snippet extraction LLM 908. The step of generating the asset-specific controls answering and snippet extraction instructions 906 can include inputting a detailed set of instructions into the controls answering and snippet extraction LLM 908 that provide the controls answering and snippet extraction LLM 908 with instructions 906a for answering a control using a document from the corporate repository, instructions 906b for using example set of database 904, instructions 906c for using the controls and other fields, instructions 906d identifying the possible answers, the meaning of the possible answers and using the possible answers, instructions 906e for handling answer conflicts within and across various documents, instructions 906f for producing the output, and instructions 906g for structuring the answers output to simplify further processing.

An example will now be discussed to illustrate how these instructions 804 can be generated for input into the controls rephrasing LLM 806.

With respect to instructions 906a for answering a control using a document from the corporate repository, the instructions may state:

“You are a question-answering system. You specialize in producing reliable, factual answer to the given closed-ended question based on a given set of documents. You should produce the answers to the given question only based on the given set of documents. You do not hallucinate. The question you need to answer is indicated by “Question” and the set of documents to seek the answer from is indicated by “Documents”. The set of documents is a list of dictionaries represented, for example, as follows: [{“ID”: unique document identifier 1, “Content”: Content of the document 1}, {“ID”: unique document identifier 2, “Content”: Content of the document 2}, {“ID”: unique document identifier 3, “Content”: Content of the document 3}]. You should produce an answer to the given question from each of the given document only using the given document content. For the given question, you should produce at least one answer from the given documents. Your answer be one of “Yes”, “No”, or “Unknown”. In addition to the answer itself, wherever applicable, you should also output one or two sentences of text that clearly supports the answer from each document.”

The instructions 906a can specify a question-answering system framework specialized for closed-ended questions to generate evidence-based answers for each control question while maintaining traceability to the source documents. As inputs, instructions 906a can require as input format specifications a question field indicating the control to be answered, a documents field containing a list of dictionaries, each with a unique document identifier, and the actual content of the document. The constraints on answer generation can be that the answers must be derived solely from the provided document content and at least one answer must be produced for each input control. In one example, the instructions 906a can specify that the answer format is limited to yes, no, or unknown, and that supporting evidence in the form of one or two sentences of textual evidence from the source document should be output where applicable. In other examples, the question can be non-Boolean and the answer format is accordingly adjusted:
open-ended (descriptive) inquiries;
evidence- or documentation-based inquiries;
selection/single-choice/multiple-choice/structured inquiries;
numeric or metric-based inquiries;
ranking or rating inquiries;
scenario-based (hypothetical) inquiries;
comparative or benchmarking inquiries;
timeline or chronology-based inquiries;
policy compliance check inquiries;
conditional or decision-tree inquiries; or
identifier or code-based inquiries.

With respect to instructions 906b for using example set of database 904, the instructions may state:

“Here is a set of Question-Documents Set-Answers Set-Snippets Set quadruples as a JSON. The given question has been answered from each of the document in the Documents set. The answers for the question from the documents in the Documents Set is in the Answers set. The Snippets set contain supporting evidences from the documents for each answer. You should look at each question, the corresponding set of documents, the corresponding set of answers from the set of documents and the corresponding set of snippets that support the answer and learn the inherent relationship that exists between the question-document-answer-snippet. You will then use that knowledge to produce correct and relevant and document-supported answers to the given question.”

The instructions 906b can specify how the examples in database 904 provide a question-answering system framework specialized for closed-ended questions specific input format specifications. The instructions 906b define constraints govern answer generation, as answers must be derived solely from the provided document content without external knowledge incorporation, and at least one answer must be produced from the set of documents. The output requirements specified by the example can dictate that answer formats with supporting evidence in the form of one or more sentences from the source document. Document processing instructions specify that each document in the input set must be analyzed independently while the system extracts relevant information to answer the given question from each document. Answer justification can be mandatory, requiring the LLM 908 to provide textual evidence from the source document to support the generated answer. This input structure enables the LLM 908 to process multiple documents, extract relevant information, and generate consistent, evidence-based answers for each control question while maintaining traceability to the source documents.

Table 4 provides examples of Question-Documents Set-Answers Set-Snippets Set quadruples:

| Question | Document | Answer | Snippet |
|---|---|---|---|
| Are AI-systems of | The AI can also affect attention and concentration. It can be controlling, | Yes | In building this |
| external | overloading or disturbing user attention with constant context switching or | | AI system, |
| suppliers used? | many undifferentiated choices. Alternatively, the AI can be supportive, enabling | | several third |
| | and encouraging concentration and attention. | | party-developed |
| | Finally, the AI application can affect users' knowledge and feelings. It can be | | ML models and |
| | controlling, presenting facts and information based on fears or in a confusing or | | AI components |
| | manipulative manner. Conversely, the AI can be supportive, enabling users to | | are being |
| | rethink, learn, and express. | | utilized. This is a |
| | In building this AI system, several third party-developed ML models and AI | | because of the |
| | components are being utilized. This is a because of the growing reliance on | | growing reliance |
| | external expertise in the field of AI. Furthermore, it is reassuring to note that | | on external |
| | the data processing, AI algorithms, and data usage are all in compliance with | | expertise in the |
| | the applicable laws and regulations, particularly those pertaining to data | | field of AI. |
| | protection and security. This compliance is not only observed but also | | |
| | contractually agreed upon, ensuring a legal and ethical approach to AI | | |
| | implementation. | | |
| Will the AI | The AI can also affect attention and concentration. It can be controlling, | Unknown | |
| system be used | overloading or disturbing user attention with constant context switching or | | |
| in Law | many undifferentiated choices. Alternatively, the AI can be supportive, enabling | | |
| enforcement? | and encouraging concentration and attention. | | |
| | Finally, the AI application can affect users' knowledge and feelings. It can be | | |
| | controlling, presenting facts and information based on fears or in a confusing or | | |
| | manipulative manner. Conversely, the AI can be supportive, enabling users to | | |
| | rethink, learn, and express. | | |
| | In building this AI system, several third party-developed ML models and AI | | |
| | components are being utilized. This is a because of the growing reliance on | | |
| | external expertise in the field of AI. Furthermore, it is reassuring to note that | | |
| | the data processing, AI algorithms, and data usage are all in compliance with | | |
| | the applicable laws and regulations, particularly those pertaining to data | | |
| | protection and security. This compliance is not only observed but also | | |
| | contractually agreed upon, ensuring a legal and ethical approach to AI | | |
| | implementation. | | |
| Will the AI | The development and use of the AI system are not entirely in line with the | No | The AI system is |
| system be used | fundamental European values, particularly in terms of non-discrimination, | | not intended for |
| in Safety | transparency towards users, and accessibility. Despite the importance of these | | use in safety |
| components with | values, the system does not fully adhere to them. | | components |
| a third party | The AI system is not intended for use in safety components that require a third- | | that require a |
| conformity | party conformity assessment. Similarly, it is not designed for use in the | | third-party |
| assessment? | education and vocational training sector. The system is also not planned to be | | conformity |
| | utilized in law enforcement or in the administration of justice and democratic | | assessment. |
| | processes. | | |
| | Despite the importance of user reliance on the system, measures have not | | |
| | been taken to ensure that the user relies on the system at an appropriate level, | | |
| | such as by visualizing the confidence score. The system does not process only | | |
| | essential data for its purpose, which is a significant concern. | | |
| Has the ability to | In terms of security, measures to protect the system against external threats, | Yes | The system does |
| kill the AI | particularly AI-specific malicious attacks, have been implemented. This includes | | have a kill |
| | threats such as membership inference and adversarial attacks. Furthermore, | | switch, and |
| | resilient fallback plans to set the AI into a safe state in case of any form of | | users have been |
| | system failure have been defined. | | informed about |
| | The system does have a kill switch, and users have been informed about its | | its application |
| | application and consequences. A detailed risk assessment has been carried out, | | and |
| | and it has been documented accordingly. This includes potential risks and their | | consequences. |
| | consequences for individuals, society, the company, and the environment. | | |
| inference been | Measures and processes to avoid risks have been implemented. The level of | | |
| implemented? | autonomy, type and amount of oversight and monitoring, necessary security | | |
| | measures, user communication, and the scope and purpose of the AI have been | | |
| | appropriately planned according to the likelihood of occurrence and | | |
| | consequences of the potential risks. | | |
| Do the | The policies and procedures of Acme's Compliance Risk Framework include | No | Acme has |
| conditions for | certain conditions for members to use its order electronic systems. Acme has | | implemented |
| using the | implemented pre-trade controls on price and volume. Acme has also | | pre-trade |
| electronic order | implemented post-trade controls. Acme has adequately assessed all trading | | controls on price |
| submission | venue members to ensure that they meet the required qualifications for staff in | | and volume. |
| systems cover | key positions. As part of its Compliance Monitoring program Acme carries out | | |
| pre-trade | regular testing to ensure that its members conform to technical and functional | | |
| controls on price, | requirements. The policy that covers this requirement is in the process of being | | |
| volume, and | updated. Members have the option to provide direct electronic access. Acme | | |
| value of orders? | has undertaken due diligence of prospective members. Risk-based assessments | | |
| | are conducted annually as part of the Compliance Monitoring Program and the | | |
| | outcomes reviewed to ensure that all members meet the requirements. | | |
| | However, there is presently a backlog for these assessments due to | | |
| | understaffing in the Compliance department and this is being addressed as part | | |
| | of an agreed remedial action plan. See answer to Article 7(4). Sanctions are | | |
| | imposed for members that do not comply with Acme's conditions. Records are | | |
| | maintained for the minimum period and are updated as part of annual policy | | |
| | review cycle. Records are maintained for the minimum period and are updated | | |
| | as part of annual policy review cycle. Yes, records are kept for at least 5 years | | |
| | and are updated annually as part of the Compliance Monitoring Program. | | |
| | Records for the annual risk-based assessments of all members are maintained. | | |
| | It is being investigated if records of sanctioned members have been maintained | | |
| | for a minimum of five years. | | |
| Have trading | The policies and procedures of Acme's Compliance Risk Framework include | Yes | Risk-based |
| venues | certain conditions for members to use its order electronic systems. Acme has | | assessments are |
| conducted a risk- | implemented pre-trade controls on price and volume. Acme has also | | conducted |
| based | implemented post-trade controls. Acme has adequately assessed all trading | | annually as part |
| assessment of | venue members to ensure that they meet the required qualifications for staff in | | of the |
| their members' | key positions. As part of its Compliance Monitoring program Acme carries out | | Compliance |
| compliance with | regular testing to ensure that its members conform to technical and functional | | Monitoring |
| the specified | requirements. The policy that covers this requirement is in the process of being | | Program and the |
| conditions at | updated. Members have the option to provide direct electronic access. Acme | | outcomes |
| least once a | has undertaken due diligence of prospective members. Risk-based assessments | | reviewed to |
| year? | are conducted annually as part of the Compliance Monitoring Program and the | | ensure that all |
| | outcomes reviewed to ensure that all members meet the requirements. | | members meet |
| | However, there is presently a backlog for these assessments due to | | the |
| | understaffing in the Compliance department and this is being addressed as part | | requirements. |
| | of an agreed remedial action plan. See answer to Article 7(4). Sanctions are | | |
| | imposed for members that do not comply with Acme's conditions. Records are | | |
| | maintained for the minimum period and are updated as part of annual policy | | |
| | review cycle. Records are maintained for the minimum period and are updated | | |
| | as part of annual policy review cycle. Yes, records are kept for at least 5 years | | |
| | and are updated annually as part of the Compliance Monitoring Program. | | |
| | Records for the annual risk-based assessments of all members are maintained. | | |
| | It is being investigated if records of sanctioned members have been maintained | | |
| | for a minimum of five years. | | |

With respect to instructions 906c identifying the possible answers, the meaning of the possible answers and using the possible answers, the instructions may state:

“As indicated above, the possible answers to a given question are “Yes”, “No” or “Unknown”.
(1) You should be very strict when answering “Yes” to a question. Only when the document contains definitive evidence that results in a “Yes” answer to the question, your response will be a “Yes”.
(2) You should be very strict when answering “No” to a question. Only when the document contains definitive evidence that results in a “No” answer to the question, your response will be a “No”.
(3) If the document does not contain definitive “Yes” or “No” answer to the question, you should respond with “Unknown”.
(4) If the question asked covers a set of items or conditions, your answer should be:
   a. “Yes” only if all the items or conditions in the set is covered in the document.
   b. “No” if only a subset of the items or conditions in the set is covered in the document.
   c. “Unknown” if none of the items or conditions in the set is covered in the document.”

Instructions 906c can specify that answers are only to be answered concretely when the document set contains definitive evidence for answering the question, otherwise the LLM 908 outputs an answer indicating that the answer is unknown. For questions cover more than one item or condition, instructions 906c can specify that answers are only to be answered concretely when the document set contains definitive evidence for answering all items or conditions of the question, otherwise the LLM 908 outputs an answer indicating that the answer is unknown.

With respect to instructions 906d for handling answer conflicts within and across various documents, the instructions may state:

“Your output should be a JSON that, for example, looks like: [{“ID”: unique document identifier
1, “Answer”: “Yes”, “Supporting Text”: One or two sentences from document 1 text that
supports the “Yes” answer}, {“ID”: unique document identifier 2, “Answer”: “No”, “Supporting
Text”: One or two sentences from document 2 text that supports the “No” answer}, {“ID”:
unique document identifier 3, “Answer”: “Unknown”, “Supporting Text”: “”}]. Because it is
required that the document should contain a definitive “Yes” or “No”, the supporting text is
required when the answer is “Yes” or “No”.”

Instructions 906d can specify that if two documents or two different portions of one document produce different answers, the output should include a structure data object for each answer, with each structured data object including the answer, a unique identifier for the document providing the answer, and one or more sentences of the text supporting the answer.

With respect to instructions 906e for producing the output, the instructions may state:

“It is often possible and, in fact, likely that a given question has conflicting answers within the
same document or across two different documents. In these cases, your output should be
structured as follows:

| | |
|---|---|
| (1) | In the same document, one area of the document definitively produces a “Yes” |
| | answer and another area of the same document definitively produces a “No” answer. |
| | In this situation, your JSON output list should include both answers coming from the |
| | same document: [{“ID”: unique document identifier D, “Answer”: “Yes”, |
| | “Supporting Text”: One or two sentences from document D text that supports the |
| | “Yes” answer}, {“ID”: unique document identifier D, “Answer”: “No”, “Supporting |
| | Text”: One or two sentences from document D text that supports the “No” answer}] |
| (2) | One document definitively produces a “Yes” answer and a different document |
| | definitively produces a “No” answer. In this situation, your JSON output list should |
| | include both answers coming from the two documents: [{“ID”: unique document |
| | identifier D1, “Answer”: “Yes”, “Supporting Text”: One or two sentences from |
| | document D1 text that supports the “Yes” answer}, {“ID”: unique document |
| | identifier D2, “Answer”: “No”, “Supporting Text”: One or two sentences from |
| | document D2 text that supports the “No” answer}] |
| (3) | Follow the above pattern when two documents produce definitive “Yes” as the |
| | answers. |
| (4) | Follow the above pattern when two documents produce definitive “No” as the |
| | answers. |
| (5) | All of the above specifications apply when more than two documents are available for |
| | a given question.” |

Instructions 906e can supplement instructions 906d and specific that if two documents or two different portions of one document produce the same answer two or more times, the output should include a structure data object for each answer, with each structured data object including the answer, a unique identifier for the document providing the answer, and one or more sentences of the text supporting the answer.

With respect to instructions 906f for structuring the answers output into data objects that associate each control with a respective answer and respective supporting text for the answer to simplify further processing, the instructions may state:

“Your output should be a valid JSON as described above. Do not include any other comments
such as ″JSON output″, ″Here is the JSON″ etc.”

The method 900 then includes a step of answering each of the asset-specific controls by inputting the data record 808, the documents from the company repository 902, the examples from the database 904 and the snippet extraction instructions 906 into controls answering and snippet extraction LLM 908, which analyzes each control in data record 808 using the examples in the database 904, and snippet extraction instructions 906 to searching through the company repository 902 to find answers for each of the asset-specific controls and extract snippets of the text in company repository 902 that answer the asset-specific controls. The controls answering and snippet extraction LLM 908 outputs the asset-specific control answer into the data record 112 to generate an asset-specific controls and answers data record 910 including a plurality of data strings each including the initial controls, the asset-specific controls, regulations, citation information, the assigned factor, the assigned asset information and the assigned entity information, and answers to the asset-specific controls.

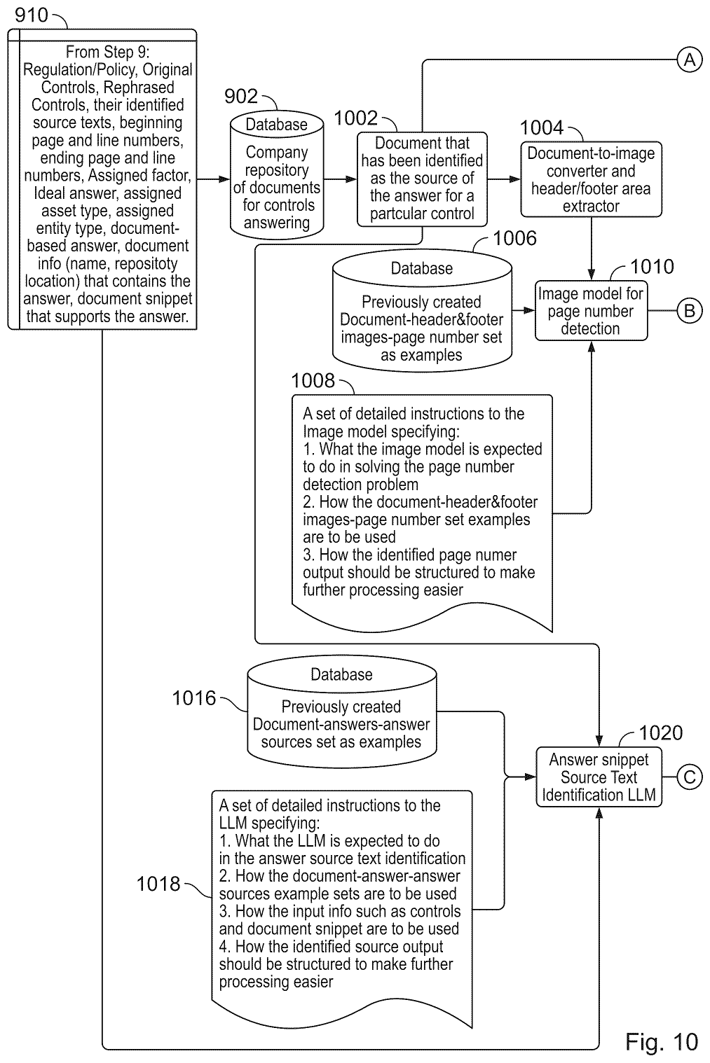

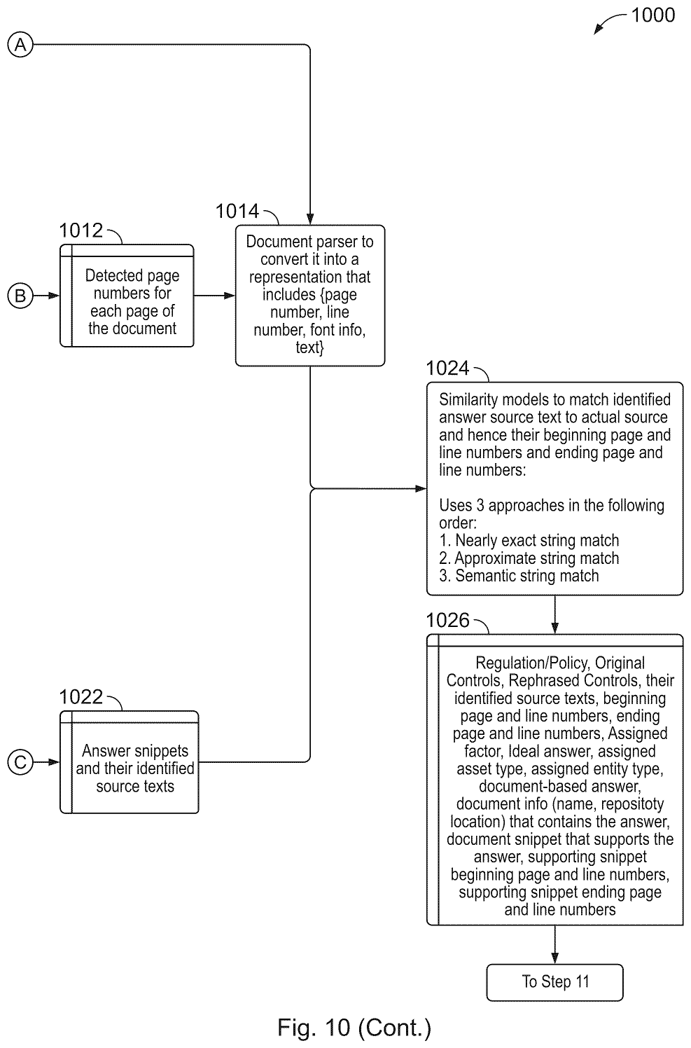

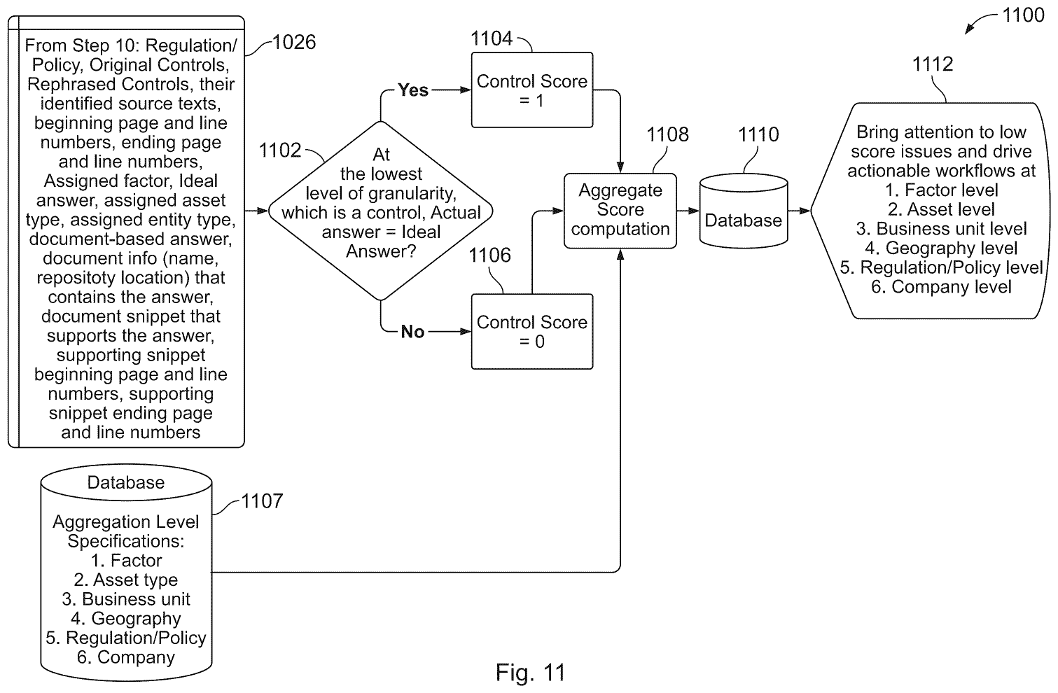

FIG. 10 shows a method 1000 for generating citation information for the extracted snippets. The retrieval of method 1000 provides an electronic record that optimizes information retrieval and transparency. The asset-specific controls and answers data record 910 can be accessed and compared to the company repository 902 to identify documents 1002 that are the source of the answers for the controls. The identified documents 1002 are then processed by a document-to-image converter and header/footer area extractor 1004 that can operate in the same manner as extractor 304. The document-to-image converter and header/footer area extractor 1004 can set the number of pixels at the top and bottom of each page that are extracted to identify headers and footers.

The method 1000 includes a step of storing previously-created document header and footer images page number set as examples in a header/footer database 1006 that can include the same examples as database 308. The document header and footer images page number set includes images of the header and/or footer of the document and are used to identify the page number.

The method also includes a step of generating training instructions 1008, which can be the same as instructions 306, for inputting into an image model 1010, which can be the same as model 308. The step of generating training instructions 1008 can include inputting a detailed set of instructions into the image model 1010 that provide the image model 1010 with instructions 1008a for solving the page number detection problem, instructions 1008b for using the document header and footer images page number set examples stored in the header/footer database 1006, and instructions 1008c for structuring the identified page number output to simplify further processing.

The method 1000 then includes a step of performing a page number processing operation by inputting the document header and footer images page number set in the header/footer database 1006, the document-to-image converter and header/footer area extractor 1004, and the training instructions 1008 into the image model 1010, which outputs detected pages numbers 1012 for each page of the document.

The detected pages numbers 1012 and the electronic regulation document are then input into a document parser 1014 that converts the electronic regulation document into a data structure, which can be an in-memory dictionary, that can include a plurality of structured data objects (e.g., JSON objects) that each include {page number, line number, font info, line text} to associate location and font info with each line of text of the document 1002.

The method 1000 also includes a step of storing previously-created document-answer-answer sources set, which can be a plurality of structured data strings, for example JSON strings, including an example answers document, example answers generated from the example answers document and the source text of the example answers document serving as the source of the example answers. The structure data strings can each include representations of bi-directional pointer between answers and associated source document, as examples in an answer sourcing database 1016. The method 1000 also includes a step of generating training instructions 1018 for inputting into an answer source text identification LLM 1020. The step of generating training instructions 1018 can include inputting a detailed set of instructions into the answer source text identification LLM 1020 that provide the answer source text identification LLM 1020 with instructions 1018a for identifying the source text of each answer, instructions 1018b for using the document-answer-answer sources set examples stored in the answer sourcing database 1016, instructions 1018c for specifying how the inputs of the controls and documents snippets from data structure 910 are to be used, and instructions 1018d for structuring the identified source output to simplify further processing. The instructions 1018a for identifying the source text of each answer may include detailed guidance on parsing and analyzing the content of the document 1002. These instructions may direct the control source text identification LLM 1020 to employ natural language processing techniques to identify key phrases, company practice terminology, and compliance language that closely aligns with the answers. The LLM may be instructed to consider contextual information, such as section headings, paragraph structures, and semantic relationships within the document, to accurately pinpoint the source text for each answer. Additionally, the instructions may specify methods for handling complex scenarios, such as when a control is derived from multiple sections of the document or when the source text is not explicitly stated but implied through a combination of clauses.

Instructions 1018b may provide detailed guidance on leveraging the document-answer-answer snippet-answer sources set examples stored in the answer sourcing database 1016. These instructions may direct the LLM 1020 to analyze the patterns and relationships between example controls and their corresponding source texts in the training data. The LLM 1020 may be instructed to identify common linguistic structures, semantic similarities, and contextual cues that link controls to their sources across various document types and business domains. The instructions may also specify how to adapt the learned patterns to new documents and answer sets, accounting for variations in document structure, terminology, and business focus. This may include techniques for transfer learning and fine-tuning the model's understanding based on domain-specific nuances present in the current document being processed.

The instructions 1018c for specifying how the inputs of the document-answer-answer snippet-answer source from data structure 910 are to be used. Specifically, instructions 1018c can specify that document 1002 is to be parsed to identify the answer snippet, and then associate the answer snippet with the answer source, e.g., a specific section or heading in the answer document, in the same way as the answer snippets and answer sources are associated in the document in the examples in data structure 1016.

The instructions 1018d for structuring the identified answer snippet-answer source output may provide specific guidelines for formatting and organizing the output of LLM 1020. These instructions may direct the LLM 1020 to generate a standardized output format, such as a JSON structure, that includes the answer snippet, its unique identifier, the identified source text. The instructions may also specify how to handle and represent bi-directional relationships between answer snippets and source texts, enabling efficient navigation and cross-referencing. Additionally, the instructions may include guidelines for metadata generation, such as confidence scores for each source text identification, to support quality assurance and manual review processes in downstream applications.

The method 1000 then includes a step of performing a page number processing operation by inputting the document-answer-answer sources set examples stored in the answer sourcing database 1016, the answer and corresponding document snippet from controls and answers data record 910, and the training instructions 1018 into answer source text identification LLM 1020, which outputs the answers and their identified source text in a data structure 1022, which can be an in-memory dictionary, including a plurality of structure data objects, each including one of the text snippets and the source text.

The data structure 1022 can for example have the following exemplary data objects: [{‘Answer Snippet’: ‘The confidential information is removed from the training data’, ‘Source’: ‘§ 304.1(c)’}, {‘Answer Snippet’: ‘The model was not trained using unlicensed copyrighted materials’, ‘Source’: ‘§ 304.1(f)’}] The data structure output by parser 1014 and the answers and their identified source text 1022 are then input into similarity models 1024 that match the identified source text to actual source and hence their beginning page and line numbers and ending page and line numbers. The similarity models 1024 use threes approaches in the following order: (1) an exact or nearly exact string match (90-100% string match), (2) approximate string match (70-90% string match), and (3) semantic string match. In particular, for each data object of data structure 1022 including identified source text, the similarity model compares the text in data structure 1022 to the data objects in the data structure output by parser 1014 to first check for (1) an exact or nearly exact string match (90-100% string match), if (1) is not found then moves to (2) approximate string match (70-90% string match), and if (2) is not found moves to (3) semantic string match.

The similarity models 1024 outputs a controls-citation data structure 1026 that includes a plurality of structured data objects, each including the supporting snippet beginning page and line numbers, supporting snippet ending page and line numbers, along with all of the information in asset-specific controls and answers data structure 910.

FIG. 11 shows a method 1100 of providing a compliance score and posture visibility for the asset-specific controls based on the controls-citation record 1026. An answer assessment model 1102 analyzes the controls-citation record 1026 and compares the ideal answer for each of the initial controls with the generated answer for the asset-specific control corresponding to the respective initial control, and outputs a control score for each generated answer. It is noted that, in some embodiments, method 800 can be omitted and thus answer assessment model 1102 can analyze the controls-citation record 1026 and compare the ideal answer for each of the initial controls with the generated answer for the respective initial control, and output a control score for each generated answer If the ideal answer (yes or no) and the generated answer (yes or no) are the same, then the answer assessment model 1102 outputs an affirmative answer 1104 to generate a control score of 1. If the ideal answer (yes or no) and the generated answer (yes or no) are different, then the answer assessment model 1102 outputs a negative answer 1106 to generate a control score of 0.

The control score can then be aggregated by an aggregate score computation module 1108 based on a number of aggregation level specifications stored in an aggregation level specifications database 1107. The aggregation levels can include a factor level, an asset type level, regulation/policy level, company level and a plurality of hierarchal levels, which can be those stored in hierarchy description database 604. As shown in FIG. 11, the hierarchal levels can be for example business unit level and geography level.

As an example of factor level aggregation, the aggregate score computation module 1108 can add up all of the control scores for all of the controls corresponding to a factor, such as trustworthiness. The company using the enterprise software can thus have visibility of where the company stands related to compliance with regulations pertaining to the subject of trustworthiness. As an example of asset type level aggregation, the aggregate score computation module 1108 can add up all of the control scores for all of the controls corresponding to an asset type, such as AI models. The company using the enterprise software can thus have visibility of where the company stands related to compliance with regulations pertaining to the subject of AI models. As an example of hierarchy level aggregation, the aggregate score computation module 1108 can add up all of the control scores for all of the controls corresponding to a business unit. The company using the enterprise software can thus have visibility of where the company stands related to compliance with regulations pertaining to the business unit. The level aggregation scores can then be stored in an aggregate scoring database 1110, and output to a user of the enterprise software system on a graphical user interface 1112.

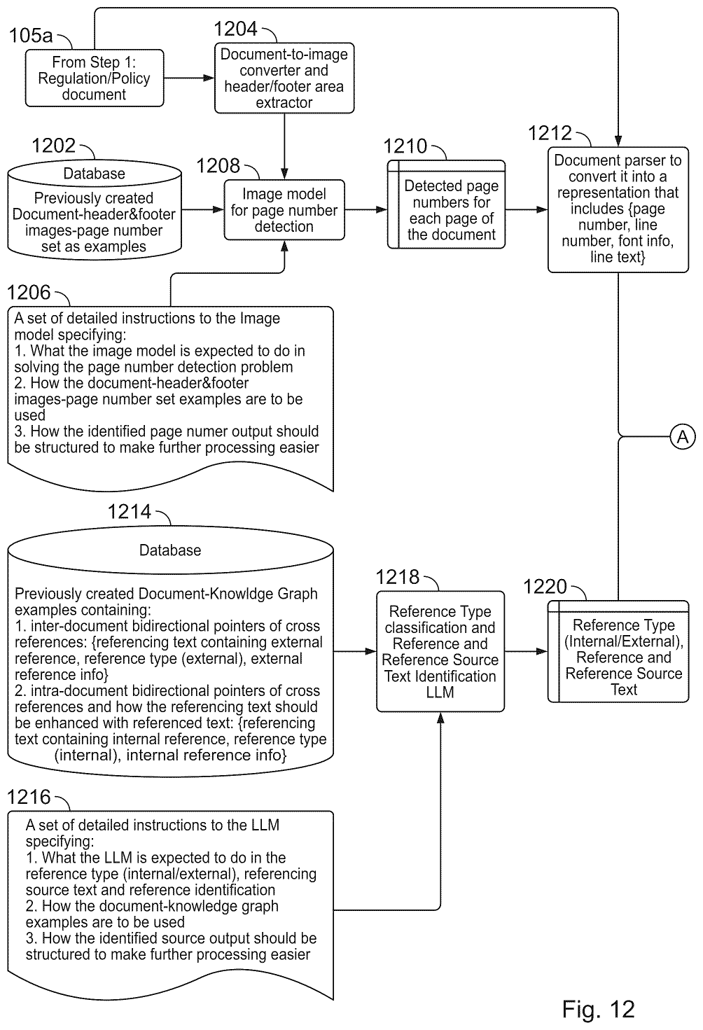

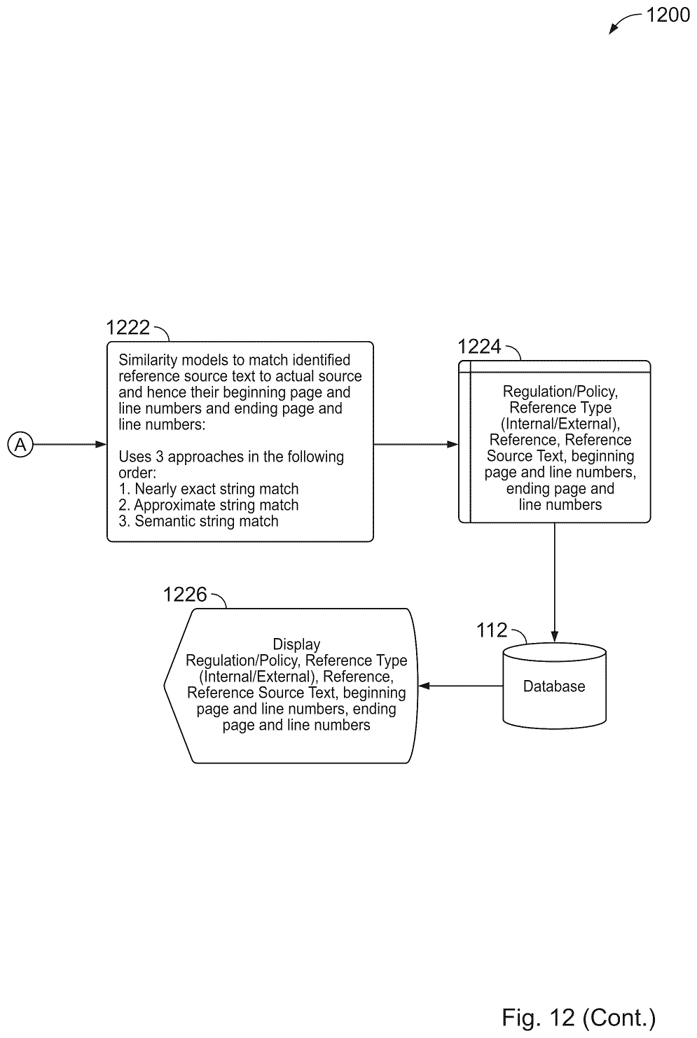

FIG. 12 shows a method 1200 of linking each cross-reference in a regulation/policy document 110 with the associated cross-referencing text that includes the cross-reference. When the cross-referenced text is used to adjust referencing text, the server computer system can record and display the reason and basis of this adjustment by displaying information generated as a structured data object 1224 and stored as a structured data string stored in a database 112. A summary of the referenced text can be included in the referencing text to show the actual referencing text that establishing confidence in the linkage as well as the linked text summary with its un-summarized original text. For example, Article 20 from EU AI Act document includes a reference to Article 74 of Directive 2013/36/EU, and method 1200 can link Article 74 of Directive 2013/36/EU with the associated cross-referencing text of Article 20 from EU AI Act (“logs automatically generated by their high-risk AI systems as part of the documentation under Articles 74 of that Directive”).

The method 1200 includes a step of storing previously-created document header and footer images page number set as examples in a header/footer database 1202, and inputting the electronic regulation documents 105 from regulation database 106 into a document-to-image converter and header/footer area extractor 1204. The document header and footer images page number set includes images of the header and/or footer of the document and are used to identify the page number. The document-to-image converter and header/footer area extractor 1204 can set the number of pixels at the top and bottom of each page that are extracted to identify header and footer.

The method also includes a step of generating training instructions 1206 for inputting into an image model 1208. The step of generating training instructions 1206 can include inputting a detailed set of instructions into the image model 1208 that provide the image model 308 with (1) instructions for solving the page number detection problem, (2) instructions for using the document header and footer images page number set examples stored in the header/footer database 1202, and (3) instructions for structuring the identified page number output to simplify further processing.

The method 1200 then includes a step of performing a page number processing operation by inputting the document header and footer images page number set in the header/footer database 1202, the document-to-image converter and header/footer area extractor 1204, and the training instructions 1206 into the image model 1208, which outputs detected pages numbers 1210 for each page of the document.

The detected pages numbers 1210 and the electronic regulation document are then input into a document parser 1212 that converts the electronic regulation document into a data structure that includes a plurality of data objects, each including {page number, line number, font info, line text} to associate location and font info with each line of text of the document 105a. The algorithm components 1202 to 1212 are the same as algorithm components 302 to 312 and the structured data object output by parser 1212 can simply be retrieved from the output of parser 312.

The method 1200 also includes a step of storing a previously-created referencing document-referenced document set, which can be a bi-directional pointer between a referencing regulation document and an associated reference to a cross-referenced regulation document, as examples in a referencing-referenced database 1214. The method 1200 also includes a step of generating training instructions 1216 for inputting into a reference type classification (i.e., whether a particular reference is internal reference within the electronic rules document or an external reference in another document outside the electronic rules document) and reference and reference source text identification LLM 1218. The step of generating training instructions 1216 can include inputting a detailed set of instructions into the text identification LLM 1218 that provide the text identification LLM 1218 with instructions 1216a for identifying the reference type (internal/external), the referencing source text and the referenced text, instructions 1216b for using the referencing document-referenced document set examples stored in the referencing-referenced database 1214 to output the reference type (internal or external), the, and instructions 1216c for structuring the identified source output to simplify further processing.

The method 1200 then includes a step of performing a reference type classification and reference and reference source text identification operation by inputting the referencing document-referenced document set examples stored in the referencing-referenced database 1214, and the training instructions 1216 into the LLM 1218, which outputs, for each reference, reference information 1220 including the reference type (internal/external), the reference and the referencing source text.

The representation 1212 and the reference information 1220 are then input into similarity models 1222 that match the identified reference source text to actual source and hence their beginning page and line numbers and ending page and line numbers. The similarity models 1222 use threes approaches in the following order: (1) an exact or nearly exact string match (90-100% string match), (2) approximate string match (70-90% string match), and (3) semantic string match. The similarity models 1222 outputs a reference-citation record 1224 that includes the name of the regulation/policy, reference type (Internal/External), reference, reference Source text, beginning page and line numbers, ending page and line numbers. The reference-citation record 1224 is stored in database 112, and output to a user of the enterprise software system on a graphical user interface 1226. The method of FIG. 12 determines and shows various references (internal to the document 105a or external to document 105a in one or more of documents 105b) and the locations of the references to provide the user with visibility.

For example, if document 105a is the original text of Article 9 from EU AI Act document called “EU AI Act.pdf” and paragraph (c) of Article 9 states: “(c) evaluation of emerging significant risks as described in point (a) and identified based on the analysis of data gathered from the post-market monitoring system referred to in Article 61;” because Article 9(c) refers to Article 61 of the EU AI Act and is an internal reference, the structured data string stored into database 1224 can be:

‘{“Regulation/Policy”: “EU AI Act.pdf”,
“Reference Type”: “Internal”,
“Reference Source Text”: “analysis of data gathered from the post-market
monitoring system referred to in Article 61”,
“beginning page and line numbers”: “15, 18”,
“ending page and line numbers”: “15, 18”}’.

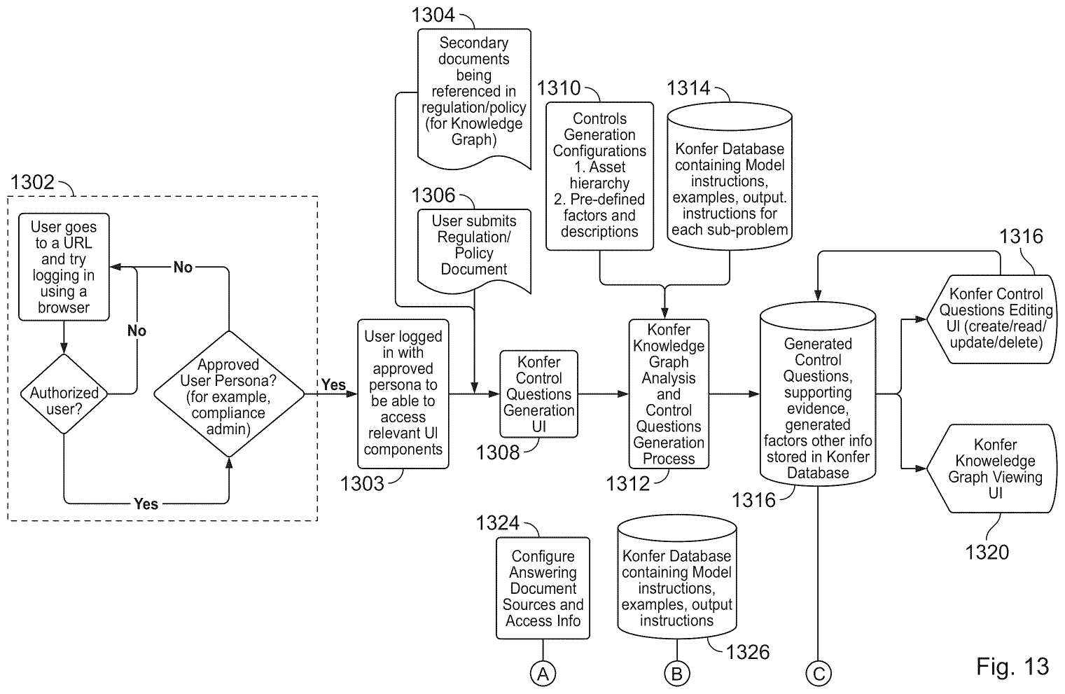

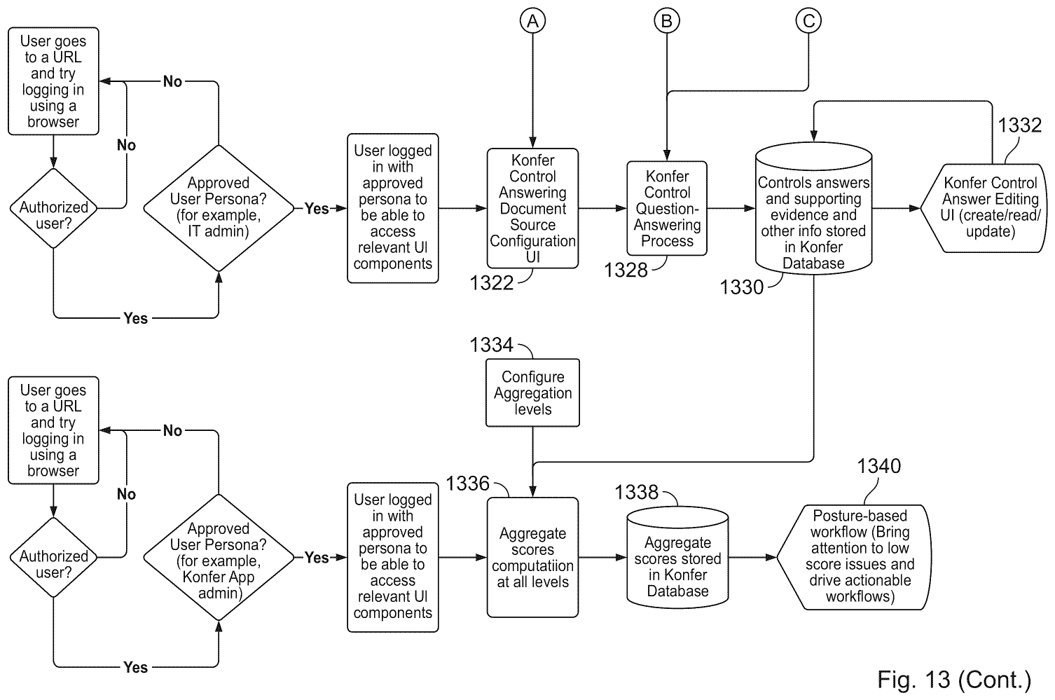

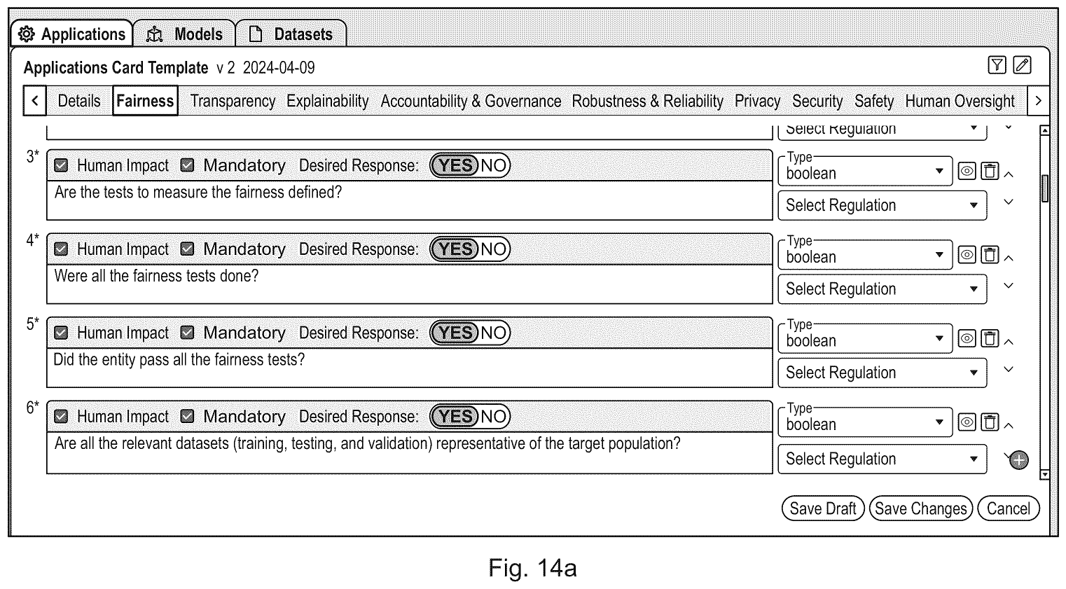

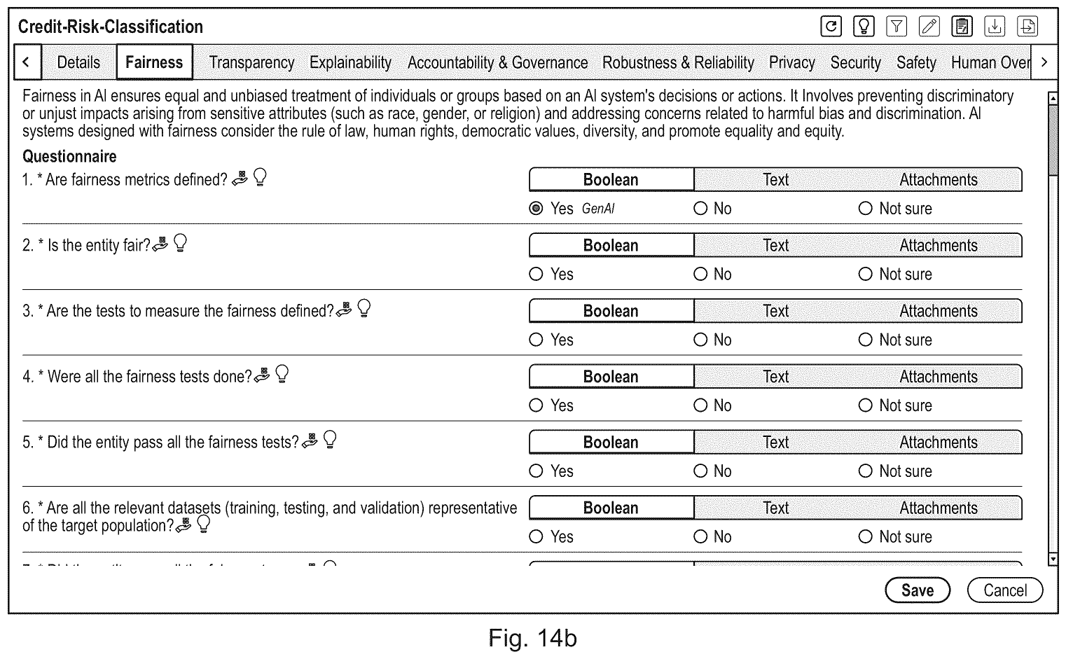

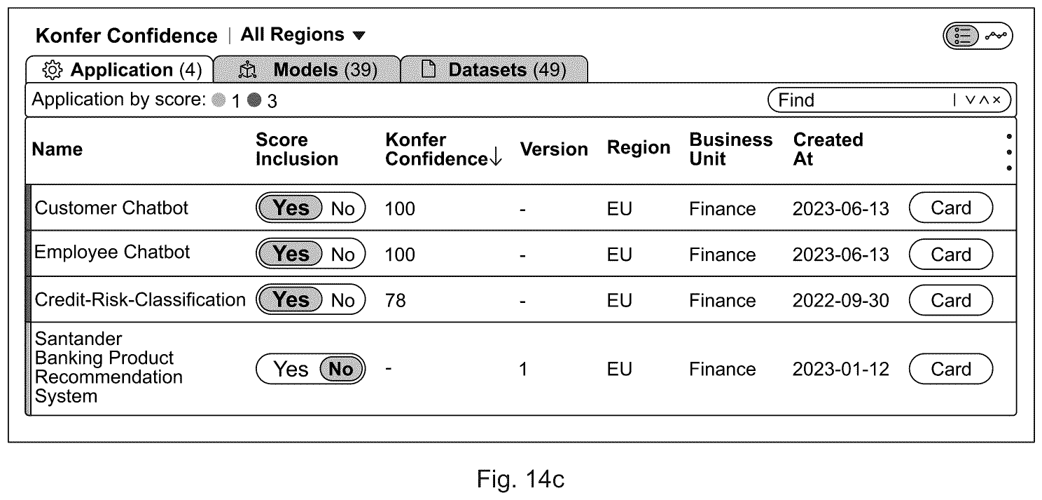

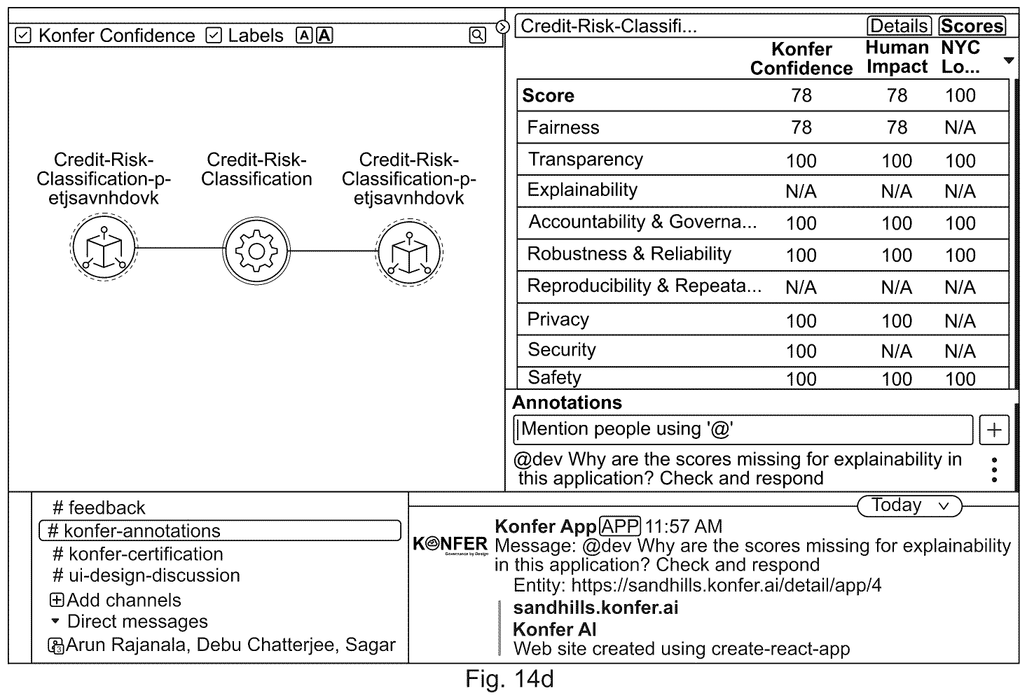

FIG. 13 schematically illustrates a server computer system can utilize the technology created in the methods of FIGS. 1 to 12 to output compliance controls, compliance control and compliance scores to a user of a remote client computer, which can be a client computer within a computing infrastructure utilizing enterprise software—i.e., an enterprise software system. As illustrated in login schematic 1302, the user of the remote client can access a URL to interact with a graphical user interface (GUI) generated by the server computer system to enter login information to interact with the server computer system.

The server computer system can then generate a GUI 1303 that allows the user of the client computer to input an electronic rules document 1304 or identifying information for the electronic rules document 1304. The electronic rules document 1304, which can be for example a government regulation, a company policy or an association policy, includes a plurality of compliance rules. The inputting of the identifying information can include inputting the name of the rules document 1304 or can include selecting the name of rules document 1304 from a drop-down menu. Upon entering of the name of the rules document 1304, the server computer system can access the rules 1304 from database 106 or, if publicly accessible, retrieve it from the internet.

The server computer system can then parse through electronic rules document 1304 and retrieve external documents 1306 referenced in electronic rules document 1304. The documents 1306 can then be processed in accordance with method 100 to output the modified reference-free content-assimilated regulation/policy document 110.

A GUI 1308 can then be displayed by the server computer system allowing the user to input control generation configurations 1310, including a hierarchy as discussed with respect to methods 600 and 1100 and a plurality of pre-defined factors and their descriptions.

The server computer system can then proceed with a knowledge graph analysis and control questions generation process 1312 that includes accessing a database 1314 that includes the model instructions, example and output instructions for performing methods 200 and 300, and optionally one or more of methods 500, 600, 700, 800 and 1200 to generate control outputs 1316 for the electronic rules document 1304. The control outputs 1316 can include the information in controls-citation record 324 and additional information resulting from the records output by one or more of methods 500, 600, 700, 800 and 1200. The controls outputs 1316 can be displayed on a control questions editing GUI 1318, as shown in FIG. 14a, and a knowledge graph viewing GUI 1320.

The user of the remote computer, if approved for access, can then access a control question-answering document source configuration GUI 1322, where the user can provide access to the controls answering information 1324, which can be the document repository 902 of method 900 or the user can upload documents for controls answering to the server computer system.

The server computer system can then proceed with a controls answering process 1326 that includes accessing a database 1328 that includes the model instructions, example and output instructions for performing method 900 to generate controls answers 1330 for the controls outputs 1316. The controls answers 1330 can include the information in asset-specific controls and answers data record 910. The controls answers 1330 can be displayed on a control answers editing GUI 1332, as shown in FIG. 14b.

The user of the remote computer, if approved for access, can then access a GUI, where the user can initiate a process of using configured aggregation levels 1332, such as those in database 1107, performed a process of aggregating scores for each of the aggregation levels in the manner described in method 1100. The aggregated scores can be stored in a database 1334, and can be displayed on a compliance score GUI 1336 that illustrates a posture-based workflow that brings attention to low score issues and drives actionable workflows.

FIGS. 14c, 14d illustrate the interactive GUI 1336, with FIG. 14c illustrating all the assets of a company—including software applications, AI models and datasets—and their corresponding scores. A user can select an asset of interest, for example “Credit Risk Classification” because the score is the lowest at 78. Upon selection of the asset, the server computer system can modify the GUI 1336 to show the view shown in FIG. 14d, which provides the details of score per factor on the right side of the GU for the asset “Credit Risk Classification.” At the bottom of the GUI, the server computer system can generate a task notification to a team communication platform, such as SLACK.

The computing machine 500 may comprise all kinds of apparatuses, devices, and machines for processing data, including but not limited to, a programmable processor, a computer, and/or multiple processors or computers. As shown, an exemplary computing machine 500 may include various internal and/or attached components, such as a processor 510, system bus 570, system memory 520, storage media 540, input/output interface 580, and network interface 560 for communicating with a network 530.

The server computer system and/or the client computing system may be implemented as a computing machine in the form of conventional computer system, an embedded controller, a server, a laptop, a mobile device, a smartphone, a wearable device, a kiosk, customized machine, or any other hardware platform and/or combinations thereof. The computing machine 500 may comprise all kinds of apparatuses, devices, and machines for processing data, including but not limited to, a programmable processor, a computer, and/or multiple processors or computers. As shown, an exemplary computing machine may include various internal and/or attached components, such as a processor, system bus, system memory, storage media, input/output interface, and network interface for communicating with a network.

In some embodiments, the computing machine may be a distributed system configured to function using multiple computing machines interconnected via a data network or system bus.

The processor may be configured to execute code or instructions to perform the operations and functionality described herein, manage request flow and address mappings, and to perform calculations and generate commands. The processor may be configured to monitor and control the operation of the components in the computing machine. The processor may be a general-purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor may be a single processing unit, multiple processing units, a single processing core, multiple processing cores, special purpose processing cores, coprocessors, or any combination thereof. In addition to hardware, exemplary apparatuses may comprise code that creates an execution environment for the computer program (e.g., code that constitutes one or more of: processor firmware, a protocol stack, a database management system, an operating system, and a combination thereof). According to certain embodiments, the processor and/or other components of the computing machine may be a virtualized computing machine executing within one or more other computing machines.

The system memory may include non-volatile memories such as read-only memory (“ROM”), programmable read-only memory (“PROM”), erasable programmable read-only memory (“EPROM”), flash memory, or any other device capable of storing program instructions or data with or without applied power. The system memory also may include volatile memories, such as random-access memory (“RAM”), static random-access memory (“SRAM”), dynamic random-access memory (“DRAM”), and synchronous dynamic random-access memory (“SDRAM”). Other types of RAM also may be used to implement the system memory. The system memory may be implemented using a single memory module or multiple memory modules. While the system memory is depicted as being part of the computing machine, one skilled in the art will recognize that the system memory may be separate from the computing machine without departing from the scope of the subject technology. It should also be appreciated that the system memory may include, or operate in conjunction with, a non-volatile storage device such as the storage media.

The storage media may store one or more operating systems, application programs and program modules such as module, data, or any other information. The storage media may be part of, or connected to, the computing machine. The storage media may also be part of one or more other computing machines that are in communication with the computing machine such as servers, database servers, cloud storage, network attached storage, and so forth.

The modules may comprise one or more hardware or software elements configured to facilitate the computing machine with performing the various methods and processing functions presented herein. The modules may include one or more sequences of instructions stored as software or firmware in association with the system memory, the storage media, or both. The storage media may therefore represent examples of machine or computer readable media on which instructions or code may be stored for execution by the processor. Machine or computer readable media may generally refer to any medium or media used to provide instructions to the processor. Such machine or computer readable media associated with the modules may comprise a computer software product. It should be appreciated that a computer software product comprising the modules may also be associated with one or more processes or methods for delivering the module to the computing machine via the network, any signal-bearing medium, or any other communication or delivery technology. The modules may also comprise hardware circuits or information for configuring hardware circuits such as microcode or configuration information for an FPGA or other PLD.

The input/output (“I/O”) interface may be configured to couple to one or more external devices, to receive data from the one or more external devices, and to send data to the one or more external devices. Such external devices along with the various internal devices may also be known as peripheral devices. The I/O interface may include both electrical and physical connections for operably coupling the various peripheral devices to the computing machine or the processor. The I/O interface may be configured to communicate data, addresses, and control signals between the peripheral devices, the computing machine, or the processor. The I/O interface may be configured to implement only one interface or bus technology. Alternatively, the I/O interface may be configured to implement multiple interfaces or bus technologies. The I/O interface may be configured as part of, all of, or to operate in conjunction with, the system bus. The I/O interface may include one or more buffers for buffering transmissions between one or more external devices, internal devices, the computing machine, or the processor.

The I/O interface may couple the computing machine to various input devices to receive input from a user in any form. Moreover, the I/O interface may couple the computing machine to various output devices such that feedback may be provided to a user via any form of sensory feedback (e.g., visual, auditory or tactile).

Embodiments of the subject matter described in this specification can be implemented in a computing machine that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Accordingly, the computing machine may operate in a networked environment using logical connections through the network interface to one or more other systems or computing machines across a network.

The processor may be connected to the other elements of the computing machine or the various peripherals discussed herein through the system bus. It should be appreciated that the system bus may be within the processor, outside the processor, or both. According to some embodiments, any of the processor, the other elements of the computing machine, or the various peripherals discussed herein may be integrated into a single device such as a system on chip (“SOC”), system on package (“SOP”), or ASIC device.

In the preceding specification, the present disclosure has been described with reference to specific exemplary embodiments and examples thereof. It will, however, be evident that various modifications and changes may be made thereto without departing from the broader spirit and scope of present disclosure as set forth in the claims that follow. The specification and drawings are accordingly to be regarded in an illustrative manner rather than a restrictive sense.

What is claimed is:

1. A computer-implemented method of automatically generating interactive compliance controls by a server computer system to a client computing system, the method comprising:
receiving, by the server computer system, a first input from the client computing system, the first input providing:
an electronic rules document or identifying information for the electronic rules document, the electronic rules document including a plurality of compliance rules; and
information related to an asset; and
outputting, by the server computer system to the client computing system and in response to the first input, generated controls corresponding to the compliance rules, the generated controls being rephrasings of the compliance rules as actionable questions and generated by inputting the electronic document into a first large language model (LLM), the first LLM generating the rules based on example inputs specifying acceptable and unacceptable control outputs for a plurality of compliance rule inputs.

2. The method as recited in claim 1, further comprising:
receiving or accessing, by the server computer system, electronic documents providing information about the asset;
inputting, by the server computer system, the electronic documents providing information about the asset into a second large language model (LLM), the second LLM being pretrained to generate answers to each of the generated controls by examples illustrating relationships between each control, a corresponding set of documents, a corresponding set of answers from the set of documents and a corresponding set of snippets.

3. The method as recited in claim 1, further comprising:
comparing each of the answers to a corresponding ideal answer and generating a score for each answer indicating whether the answer equates to the ideal answer;
arranging the generated controls into a plurality of controls levels and generating an aggregated score for each of the controls levels; and
outputting the aggregated score for each of the controls levels on a graphical user interface.

4. The method as recited in claim 3 further comprising generating the corresponding ideal answers by inputting, by the server computer system, the generated controls into an ideal answer LLM being pretrained to generate ideal answers to each of the generated controls by a list of strings containing an ideal answer example and an associated example input control.

5. The method as recited claim 1 further comprising replacing cross-references in the electronic rules document with natural language text of the cross-references by:
replacing inter-document cross-references in the electronic rules document with source text of the cross-references retrieved from one or more further natural language electronic rules documents each including at least one of the cross-references; and/or
replacing intra-document cross-references in the electronic rules document with source text from other portions of the electronic rules document.

6. The method as recited in claim 5 wherein the replacing cross-references in the electronic rules document with source text of the inter-document and/or intra-document cross-references includes:
generating a first knowledge graph, the first knowledge graph including a plurality of first nodes representing text of the electronic rules document and the source text of the cross-references,
the first nodes including first base text nodes including the text of the electronic rules document and first cross-reference nodes including the source text of the cross-references,
each of the first cross-reference nodes being linked to a corresponding one of the first base text nodes by bidirectional pointers.

7. The method as recited in claim 6 wherein the generating the first knowledge graph includes:
attaching first metadata to each of the first base text nodes, the first metadata including location information identifying a relevant location of the text of each of the first base text nodes within the electronic rules document; and
attaching first metadata to each of the first cross-reference nodes, the first metadata including location information identifying a relevant location of the source text of the inter-document and/or intra-document cross-references within the electronic rules document or the one or more further electronic rules documents.

8. The method as recited in claim 7 wherein the replacing of the cross-references in the electronic rules document with source text of the inter-document and/or intra-document cross-references includes:
generating a second knowledge graph, the second knowledge graph including a plurality of second nodes including the location information of the first metadata; and
attaching second metadata to each of the second nodes, the second metadata includes text of the plurality of rules and the text of the of cross-references,
the second metadata including second base text metadata including the text of the plurality of rules and second cross-reference text metadata including the text of the plurality of cross-references,
the second nodes including:
second base location nodes including the location information identifying the relevant location of the text of each of the second base text metadata within the natural language electronic rules document; and
second cross-reference location nodes the location information identifying the relevant location of the source text of the inter-document and/or intra-document cross-references within the natural language electronic rules document or the one or more further natural language electronic rules documents,
each of the second cross-reference location nodes being linked to a corresponding one of the second base location nodes by bidirectional pointers.

9. The method as recited in claim 1 further comprising inputting into a LLM:
the electronic rules document;
structured data objects each including a plurality of examples of acceptable and unacceptable controls for a respective example document; and
instructions to process the electronic rules document and output the generated controls to correspond to the acceptable controls and to not correspond to the unacceptable controls.

10. The method as recited in claim 9 wherein the generated controls are questions that are factual, actionable, closed-ended and present tense.

11. The method as recited in claim 9 wherein the examples of acceptable controls are grammatically correct and useful in determining whether the asset is compliant or non-compliant with rules in the electronic rules document.

12. The method as recited in claim 1 further comprising:
creating a first data structure including a plurality of first structured data objects each associating a portion of the text of the electronic rules document with location information identifying the relevant location of the portion of the text in the electronic rules document;
creating a second data structure including a plurality of second structured data objects each associating each of the generated controls with an associated portion of the text of the electronic rules document;
generating a third data structure including a plurality of third structured data objects each associating each of the generated controls with location information identifying the relevant location of the associated portion text in the electronic rules document by performing a string match of the text in the first data structure and the text in the second data structure.

13. The method as recited in claim 1 further comprising inputting into a LLM:
a data structure including example questions and for each example question an example ideal answer indicating an assert complies with a rule;
the generated controls; and
instructions for generating ideal answers for the generated controls based on the example questions and the example ideal answers.

14. The method as recited in claim 1 further comprising:
parsing a document to extract text from the document;
automatically comparing the extract texted with one of the generated controls; and
generating a structured string including an answer to the generated control along with a snippet of text providing the answer.

15. The method as recited in claim 14 further comprising generating citation information for the generated snippet of text.

16. The method as recited in claim 15 wherein the generating citation information for the generated snippet of text includes:
creating a first structured string associating the text of the electronic rules document with location information of the text in the electronic rules document;
creating a second structured string associating each of the snippets of text with the text of the electronic rules document;
generating a third structured string associating each of the snippets of text with location information of the associated text in the electronic rules document by performing a string match of the text in the first structured string and the text in the second structured string.

17. The method as recited in claim 1 further comprising autogenerating a compliance score for all of the generated controls, wherein the autogenerating of the compliance score for all of the generated controls includes inputting into a LLM a first structured string associating each of the generated controls with an ideal answer and a generated answer;
the LLM compiling the compliance score by comparing each generated answer with the corresponding ideal answer and to provide a control score for each generated control.

18. The method as recited in claim 1 further comprising:
associating, in a first structured data object, source text of each cross-reference within the electronic rules document with the cross-reference and the location of the cross-reference within the electronic rules document;
generating a second structured data object associating each cross-reference with the source text of each cross-reference;
generating a third structured data object associating the text of the assimilated electronic rules document with location information; and
generating the first structured data object by performing a string match of the source text in the first data structure and the text in the second data structure.

19. A non-transitory computer-readable media storing computer-executable instructions that, when executed on one or more processors, cause the one or more processors to perform the method as recited in claim 1.

20. A server computer system for automatically generating interactive compliance controls for a client computing system, the system comprising:
at least one processor; and
a memory coupled to the at least one processor, the memory including software modules executable by the at least one processor to:
receive a first input from the client computing system, the first input providing:
an electronic rules document or identifying information for the electronic rules document, the electronic rules document including a plurality of compliance rules; and
information related to an asset; and
output, to the client computing system and in response to the first input, controls corresponding to the compliance rules, the controls being rephrasings of the compliance rules and generated by inputting the electronic document into a first large language model (LLM), the first LLM generating the rules based on example inputs specifying acceptable and unacceptable control outputs for a plurality of compliance rule inputs.
